(19) United States
(12) Patent Application Publication
(10) Pub. No.: US 2026/0253362 A1
(43) Pub. Date: Aug. 27, 2026

(54) MULTI-FOVEA REGIONS FOR VIEWER GAZE CHANGES

(71) Applicant: QUALCOMM Incorporated, San Diego, CA (US)

(72) Inventors: Abhijeet DEY, San Diego, CA (US); Varun BANSAL, New Delhi (IN); Saurabh AGGARWAL, Bengaluru (IN); Shrey Shailesh GADIYA, Bengaluru (IN)

(21) Appl. No.: 19/064,530

(22) Filed: Feb. 26, 2025

(51) Int. Cl. G06V 10/25; G06F 3/01; G06F 3/14

(52) U.S. Cl. CPC G06V 10/25; G06F 3/013; G06F 3/14; G06V 2201/07

(57) ABSTRACT

This disclosure provides systems, devices, apparatus, and methods, including computer programs encoded on storage media, for multi-fovea regions for viewer gaze changes. An image processor may determine a first ROI and a second ROI associated with image data, where the first ROI is non-overlapping with respect to the second ROI. The image processor may generate, based on the image data, multi-foveated image data that includes a first fovea region for the first ROI and a second fovea region for the second ROI, where the first fovea region and the second fovea region have a first resolution that is higher than a second resolution of a periphery region associated with the multi-foveated image data. The image processor may output the multi-foveated image data.

### TECHNICAL FIELD

The present disclosure relates generally to processing systems, and more particularly, to one or more techniques for image processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for image processing may utilize eye-gaze location sensing to determine locations of fovea and periphery regions for dynamic resolution of image frames, but may not address high-frequency, repeatable gaze changing scenarios where a user continuously switches their gaze between two regions of interest. There is an inherent latency between gaze change prediction and updates to the fovea location, which becomes more prominent when the gaze of the user changes very rapidly, leading to latency and hence, nausea or other undesired effects on the user. There is a need for improved techniques for determinations of fovea region locations in scenarios with repeatable gaze changes of a user.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus includes a memory; and a processor coupled to the memory and, based on information stored in the memory, the processor is configured to: determine a first region of interest (ROI) and a second ROI associated with image data, where the first ROI is non-overlapping with respect to the second ROI, to generate, based on the image data, multi-foveated image data that includes a first fovea region for the first ROI and a second fovea region for the second ROI, where the first fovea region and the second fovea region have a first resolution that is higher than a second resolution of a periphery region associated with the multi-foveated image data, and to output the multi-foveated image data.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example image or surface in accordance with one or more techniques of this disclosure.

FIG. 4 illustrates an example display framework including a display processor and a display in accordance with one or more techniques of this disclosure.

FIG. 5 illustrates a video see-through sensing data flow and an example of foveation in accordance with one or more techniques of this disclosure.

FIG. 6 illustrates examples of fovea region switching and multi-fovea regions in accordance with one or more techniques of this disclosure.

FIG. 7 illustrates examples of multi-fovea region configurations in accordance with one or more techniques of this disclosure.

FIG. 8 illustrates examples of multi-fovea region optimizations in accordance with one or more techniques of this disclosure.

FIG. 9 illustrates examples of a multi-fovea architecture in accordance with one or more techniques of this disclosure.

FIG. 10 illustrates a multi-fovea architecture with synchronization in accordance with one or more techniques of this disclosure.

FIG. 11 is a call flow diagram illustrating example communications between a multi-fovea processor (MFP) and a CPU/graphics processor in accordance with one or more techniques of this disclosure.

FIG. 12 is a flowchart of an example method of image processing in accordance with one or more techniques of this disclosure.

FIG. 13 is a flowchart of an example method of image processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit. As used herein, instances of the term “region of interest” and “ROI” may refer to predicted or sensed locations of a user gaze with respect to an image frame. As used herein, instances of the term “fovea region” may refer to a region of an image that has a higher resolution than other regions. As used herein, instances of the term “multi-foveated image data” may refer to data associated with an image in which two or more fovea regions are present. As used herein, instances of the term “object detection map” may refer to a saliency map or other data structure which may be used to predict, detect, or identify an object or region associated with the gaze or probable future gaze of a user, such as based on object detection and past gazing patterns. In some examples, an object detection map may be generated by an image signal processor and/or the image signal processor may predict, detect, or identify an object or region associated with the gaze of a user. As used herein, instances of the term “joined fovea region” may refer to a high resolution region of an image that is generated based on joining or fusing together at least two separate fovea regions. As used herein, instances of the term “video see-through sensing” and “VST sensing” may refer to capturing and displaying a real-time/near real-time video feed that allows a user to see real-world objects or environments that optionally may be overlaid or combined with virtual content.

A sensor may track desired foveation for images based on the eye-gaze of a user. Foveation may include a fovea region of higher/full resolution, a periphery region having a lower, sub-sampled resolution, and an intermediate region having a resolution somewhere between the fovea and periphery regions. Depending on the position of the user's eye-gaze, the location of fovea and intermediate regions may change dynamically over image frames. High-frequency repeatable gaze changing scenarios exist when a user continuously switches their gaze between two regions of interest (e.g., such as a tennis game where the gaze of the user repeatedly switches between the players, a work environment in which a user utilizes multiple physical monitors, etc.). However, there is an inherent latency between gaze change prediction and updates to the fovea location, which becomes more prominent when the gaze of the user changes very rapidly, leading to latency and hence, nausea or other undesired effects on the user.

Aspects herein provide for foveated rendering with multiple fovea regions. A use case is video-see-through (VST) where the user is repeatedly and rapidly changing between two (or more) discrete areas of the video, which can impact the user's experience due to the latency in updating the fovea location (e.g., tennis match or viewing two physical monitors via VST). The aspects include detections for utilization of multi-fovea based on use behavior, additions of one or more fovea (or intermediate) regions based on detections indicative for multi-fovea, and optimizations to fuse multi-fovea (or intermediate) regions based on distance.

Aspects provide for identifying use-cases (via a new algorithm) where a user is continuously switching their eye-gaze between multiple specific regions and implementing a multi-fovea scheme with multi-fovea regions. Such a multi-fovea scheme enables two or more fovea regions to be generated/created, one for reach ROI associated with the continuous eye-gaze switching (e.g., from a laptop to another physical monitor and back, between players of games/sports, etc.). Thus, aspects may eliminate the continuous change of a fovea region between ROIs for a user's eye-gaze, and may remove the related latency and nausea concerns of the user. Aspects may also enable multi-fovea regions in head-mounted displays (HMDs), such as VR headsets and/or the like. In addition to enabling multi-fovea regions, aspects may further enable multiple intermediate resolution regions associated with the multi-fovea regions. In some aspects, multi-fovea and multiple intermediate regions may be further optimized by joining/fusing, some aspects may provide for synchronization such that the sensor and the processing blocks are synchronized, and some aspects may provide for user-specified ROIs.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

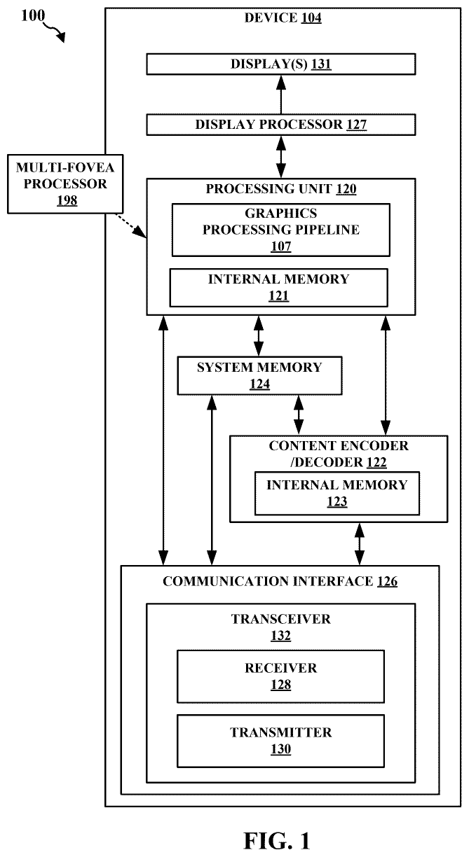

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120/display processor 127 may include and/or may receive multi-foveated image data from a multi-fovea processor 198 configured to determine a first region of interest (ROI) and a second ROI associated with image data, where the first ROI is non-overlapping with respect to the second ROI, to generate, based on the image data, multi-foveated image data that includes a first fovea region for the first ROI and a second fovea region for the second ROI, where the first fovea region and the second fovea region have a first resolution that is higher than a second resolution of a periphery region associated with the multi-foveated image data, and to output the multi-foveated image data. Although the following description may be focused on image processing, the concepts described herein may be applicable to other similar processing techniques, e.g., graphics/display processing.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

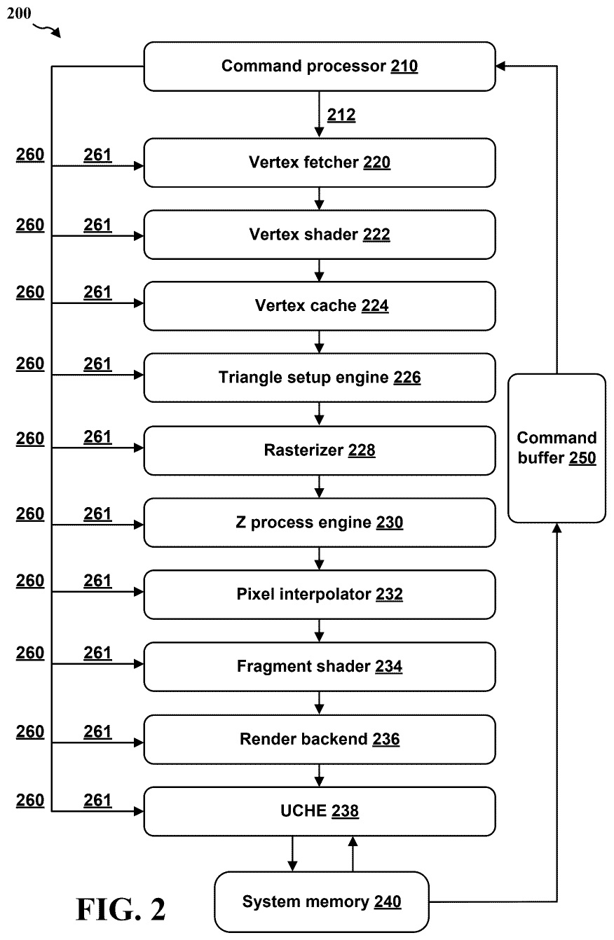

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

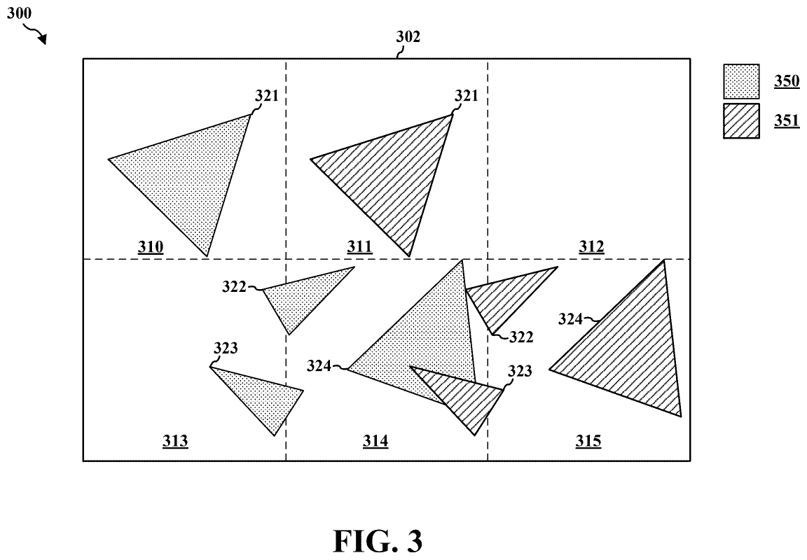

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

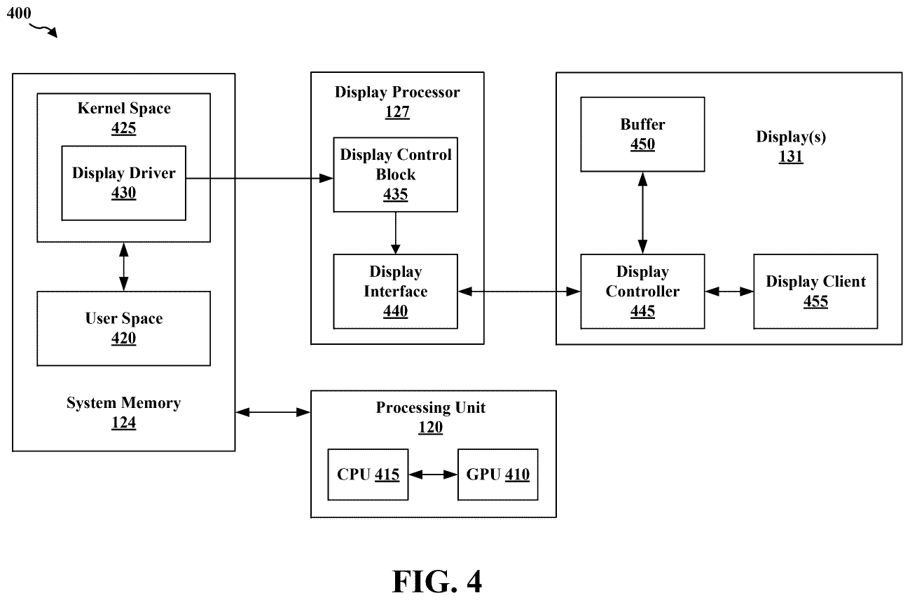

FIG. 4 is a block diagram 400 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 410 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 410 may be controlled based on one or more graphics processing commands provided by a CPU 415. The CPU 415 may be configured to execute multiple applications concurrently. In some cases, each of the concurrently executed multiple applications may utilize the GPU 410 simultaneously. Processing techniques may be performed via the processing unit 120 output a frame over physical or wireless communication channels.

The system memory 124, which may be executed by the processing unit 120, may include a user space 420 and a kernel space 425. The user space 420 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 425 may further include a display driver 430. The display driver 430 may be configured to control the display processor 127. For example, the display driver 430 may cause the display processor 127 to compose a frame and transmit the data for the frame to a display.

The display processor 127 includes a display control block 435 and a display interface 440. The display processor 127 may be configured to manipulate functions of the display(s) 131 (e.g., based on an input received from the display driver 430). The display control block 435 may be further configured to output image frames to the display(s) 131 via the display interface 440. In some examples, the display control block 435 may additionally or alternatively perform post-processing of image data provided based on execution of the system memory 124 by the processing unit 120.

The display interface 440 may be configured to cause the display(s) 131 to display image frames. The display interface 440 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 450.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 450. For example, when a Vsync pulse is generated, the display processor 127 may output new graphical content to the buffer 450. Thus, generation of the Vsync pulse may indicate that current graphical content has been rendered at the buffer 450.

Frames are displayed at the display(s) 131 based on a display controller 445, a display client 455, and the buffer 450. The display controller 445 may receive image data from the display interface 440 and store the received image data in the buffer 450. In some examples, the display controller 445 may output the image data stored in the buffer 450 to the display client 455. Thus, the buffer 450 may represent a local memory to the display(s) 131. In some examples, the display controller 445 may output the image data received from the display interface 440 directly to the display client 455.

The display client 455 may be associated with a touch panel that senses interactions between a user and the display(s) 131. As the user interacts with the display(s) 131, one or more sensors in the touch panel may output signals to the display controller 445 that indicate which of the one or more sensors have sensor activity, a duration of the sensor activity, an applied pressure to the one or more sensor, etc. The display controller 445 may use the sensor outputs to determine a manner in which the user has interacted with the display(s) 131. The display(s) 131 may be further associated with/include other devices, such as a camera, a microphone, and/or a speaker, that operate in connection with the display client 455.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 410 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

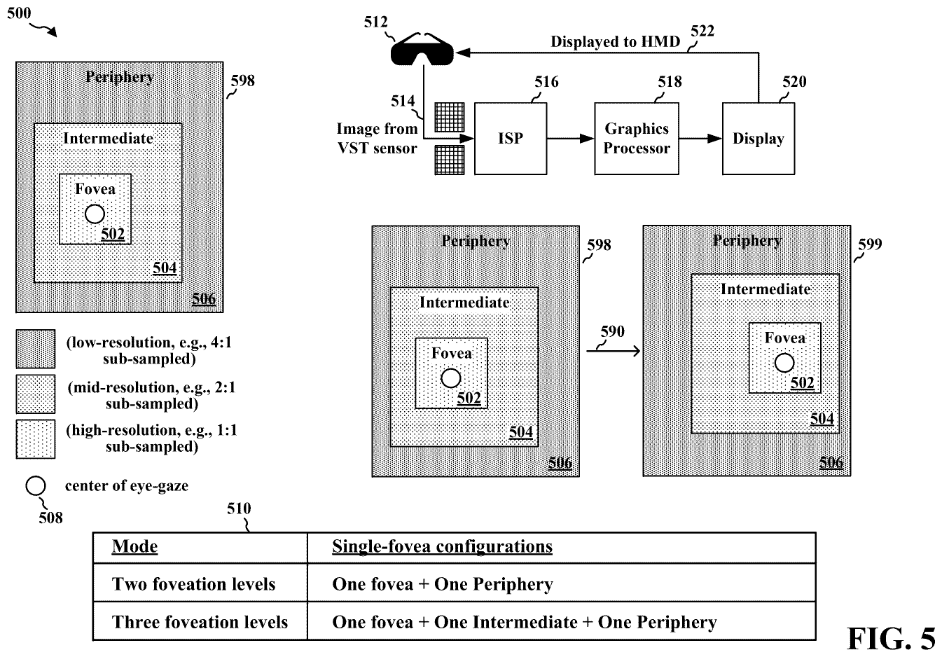

FIG. 5 illustrates a diagram 500 for a video see-through sensing data flow and an example of foveation in accordance with one or more techniques of this disclosure.

Diagram 500 shows an example image frame 598 that includes a fovea region 502, e.g., based on a center of eye-gaze 508 of a user, with a higher/full resolution (e.g., a 1:1 sub-sampled resolution of the image frame 598), a periphery region 506 having a lower resolution (e.g., a 4:1 sub-sampled resolution of the image frame 598), and an intermediate region 504 having a resolution between the fovea region 502 and the periphery region 506 (e.g., a 2:1 sub-sampled resolution of the image frame 598).

Some examples of single-fovea configurations 510 provide for modes of two or three foveation levels. For instance, a two-level configuration may include one fovea region and one periphery region, while a three-level configuration may include one fovea region, one intermediate region, and one periphery region, e.g., as shown for the image frame 598. In some examples, a HMD 512 may receive an image frame 522 from a display panel 520/a display processor. The HMD 512 may generate an image 514 via a VST sensor, e.g., the image 514 is a VST image may comprise a camera image frame combined with a virtual image frame for display to a user. The image 514 may include a fovea region, a periphery region, and optionally, an intermediate region as described above. The HMD 512 may then provide the image 514 to an image signal processor (ISP) 516 for processing, which in turn may be provided for further downstream processing by a graphics processor 518 and/or a display processor/display panel 520. The above flow may be repeated for displaying the image 514 to the HMD 512.

Based on eye-gaze location of a user, the VST sensor/foveated sensor may include the fovea, intermediate, periphery regions for the image 514. Depending on the position of the eye-gaze of the user, the location in in the image frame 598 for the fovea region 502 and the intermediate region 504 may change dynamically per frame. As one example, the image frame 598 may be indicative of a user's eye-gaze for an object/ROI to the left, e.g., the fovea region 502 and the intermediate region 504 are generated at the left side of the image frame 598 as the center of eye-gaze 508 is to the left. When there is an eye-gaze switch 590 to an object at the right side in a next image frame 599, e.g., the center of eye-gaze 508 is now to the right, the fovea region 502 and the intermediate region 504 may correspondingly change to the right side for the next image frame 599. Repetition of the eye-gaze switch 590 between the different focal points may lead to a continuous gaze and fovea change, and the latency in gaze change prediction and switching of the fovea region 502 can cause nausea/discomfort for the user.

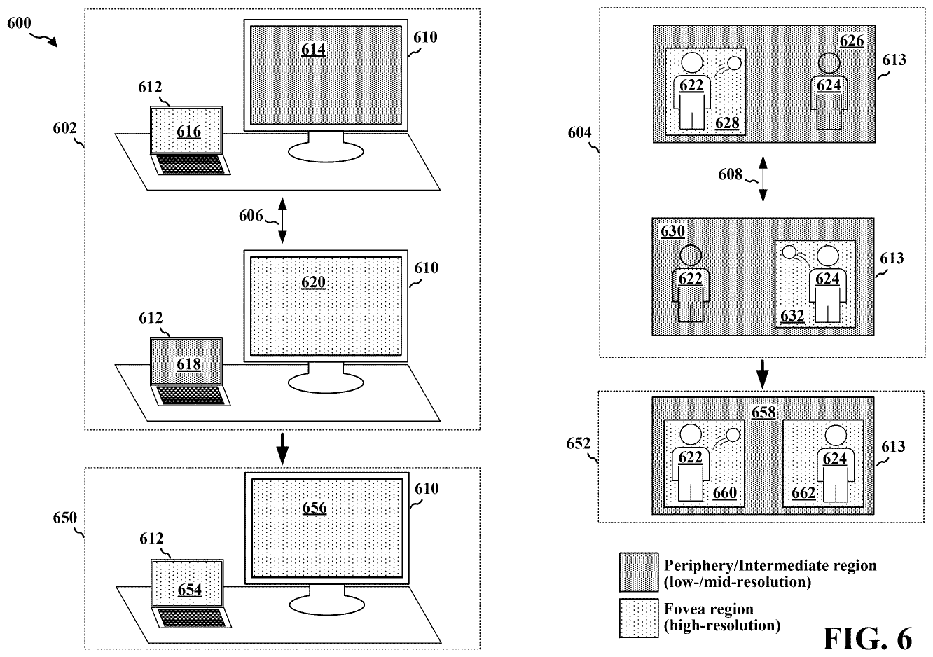

FIG. 6 illustrates a diagram 600 for examples of fovea region switching and multi-fovea regions in accordance with one or more techniques of this disclosure. Diagram 600 shows an example of fovea region switching 602 between physical monitors and an example of fovea region switching 604 between objects in an image frame.

The fovea region switching 602 may be associated with a user viewing image content on a physical display 610 and a physical display 612. In the illustrated scenario, by way of example, a user is working on workstation with a laptop having the physical display 612 and a monitor/the physical display 610, while such scenarios may include two separate physical monitors and/or the like. The user may continuously switch their gaze between two specific regions, e.g., the physical display 610 and a physical display 612, as shown by repetition of an eye-gaze switch 606. A fovea sensor (e.g., a camera, a VST sensor, a head-mounted sensor, etc.) may identify/determine the repetition of the eye-gaze switch 606 and cause a fovea region 616 for the physical display 612 and a fovea region 620 for the physical display 610 to be generated, corresponding to the focus of the user's eye-gaze between image frames. Similarly, when the physical display 612 and/or the physical display 610 are not the focus of the user, a periphery region 618 and/or a periphery region 614 may be respectively generated for the physical display 612 and the physical display 610 without a fovea region.

The fovea region switching 604 may be associated with a user viewing, for frames of image content, a first object 622 and a second object 624. In the illustrated scenario, by way of example, a user is watching image content, e.g., on a physical display, a HMD, and/or the like, such as a sporting event which has multiple areas of focus for the user: first object 622 and a second object 624. The user may continuously switch their gaze between two specific regions, e.g., the first object 622 and a second object 624 for a single physical display or HMD 613, as shown by repetition of an eye-gaze switch 608. A fovea sensor (e.g., a camera, a VST sensor, a head-mounted sensor of a HMD, etc.) may identify/determine the repetition of the eye-gaze switch 608 and cause a fovea region 628 for the first object 622 and a fovea region 632 for the second object 624 to be generated, corresponding to the focus of the user's eye-gaze between image frames. Similarly, when the first object 622 and/or the second object 624 are not the focus of the user, a periphery region 630 and/or a periphery region 626 may be respectively generated for the first object 622 and the second object 624 without a fovea region.

As noted herein, repetition of an eye-gaze switch, e.g., the eye-gaze switch 606/the eye-gaze switch 608, between the different focal points may lead to a continuous eye-gaze change and corresponding fovea change, and the latency in gaze change prediction/detection and switching of the fovea regions can cause nausea/discomfort for the user.

According to aspects, diagram 600 also shows an example of multi-fovea regions 650 for viewer gaze changes and multi-fovea regions 652 for viewer gaze changes to reduce/eliminate issues associated with continuous eye-gaze changes.

For instance, the multi-fovea regions 650 for viewer gaze changes shows the physical display 612 having a fovea region 654 while the physical display 610 concurrently has a fovea region 656. Likewise, the multi-fovea regions 652 for viewer gaze changes shows on the single physical display or HMD 613 the first object 622 having a fovea region 660 while the second object 624 concurrently has a fovea region 662, and a periphery region 658 is generated for the remaining portion of the image frame. Accordingly, aspects provide for identifying use-cases (via a new algorithm) where a user is continuously switching their eye-gaze between multiple specific regions and implementing a multi-fovea scheme with multi-fovea regions. Such a multi-fovea scheme enables two or more fovea regions to be generated/created, one for reach ROI associated with the continuous eye-gaze switching (e.g., from a laptop to another physical monitor and back, between players of games/sports, etc.). That is, aspects provide for multi-fovea regions for user gaze changes that reduce/eliminate issues associated therewith. While not shown for illustrative clarity and brevity of description, aspects also provide for more than two areas of focus for a user, as noted below.

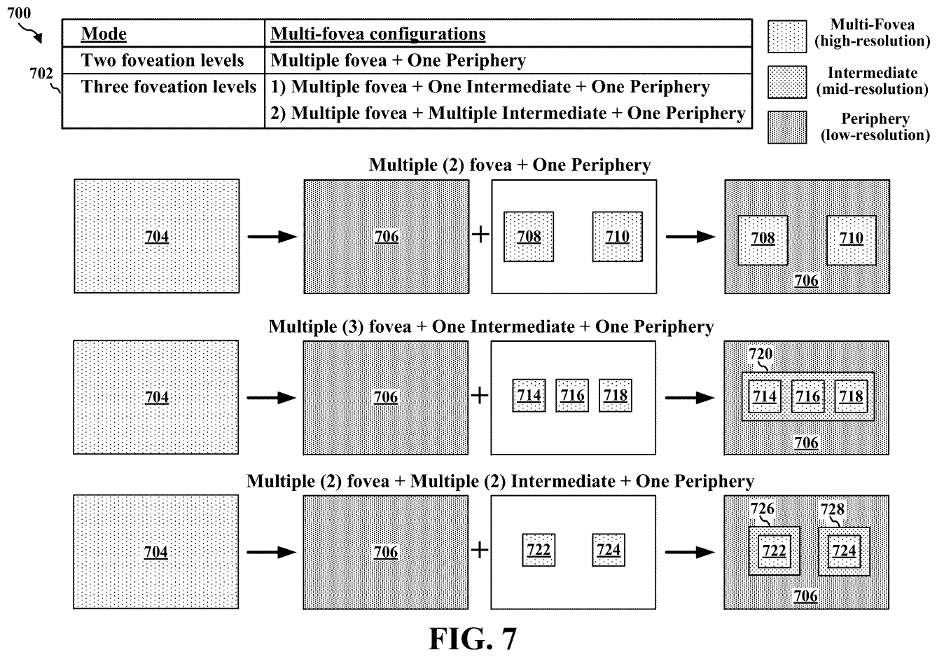

FIG. 7 illustrates a diagram 700 for examples of multi-fovea region configurations in accordance with one or more techniques of this disclosure. Diagram 700 shows multi-fovea region configurations 702, along with some example scenarios thereof.

The multi-fovea region configurations 702 may include aspects modes of two or three foveation levels. For instance, a two-level configuration may include multiple fovea regions and one periphery region, while a three-level configuration may include multiple fovea regions, one intermediate region, and one periphery region, and may include multiple fovea regions, multiple intermediate regions, and one periphery region. In diagram 700, by way of example and not limitation, a periphery region may have a low resolution (e.g., a 4:1 sub-sampled resolution of the image frame), a fovea region may have a high/full resolution (e.g., a 1:1 sub-sampled resolution of the image frame), and an intermediate region may have a mid-resolution between the resolutions of the fovea region and the periphery region (e.g., a 2:1 sub-sampled resolution of the image frame).

In some examples according to aspects, for an image frame 704 at full resolution (e.g., a native, full resolution image), a periphery region 706 (e.g., a periphery region frame) may be generated. Similarly, fovea regions and an intermediate region(s) may be generated in multi-fovea frames and intermediate region(s) frames, for combining with the periphery region 706 frame.

In one example configuration, multiple fovea regions (e.g., 2: a fovea region 708 and a fovea region 710) may be generated based on two identified/detected/sensed ROIs (e.g., monitors, objects of the image frame 704, etc.) and may be combined with the periphery region 706. In one example configuration, multiple fovea regions (e.g., 3: a fovea region 714, a fovea region 716, and a fovea region 718) and an intermediate region 720 may be generated based on three identified/detected/sensed ROIs (e.g., monitors, objects of the image frame 704, etc.) and may be combined with the periphery region 706. In one example configuration, multiple fovea regions (e.g., 2: a fovea region 722 and a fovea region 724), and two respective intermediate regions (e.g., an intermediate region 726 and an intermediate region 728) may be generated based on two identified/detected/sensed ROIs (e.g., monitors, objects of the image frame 704, etc.) and may be combined with the periphery region 706. Aspects also provide for more than three fovea regions.

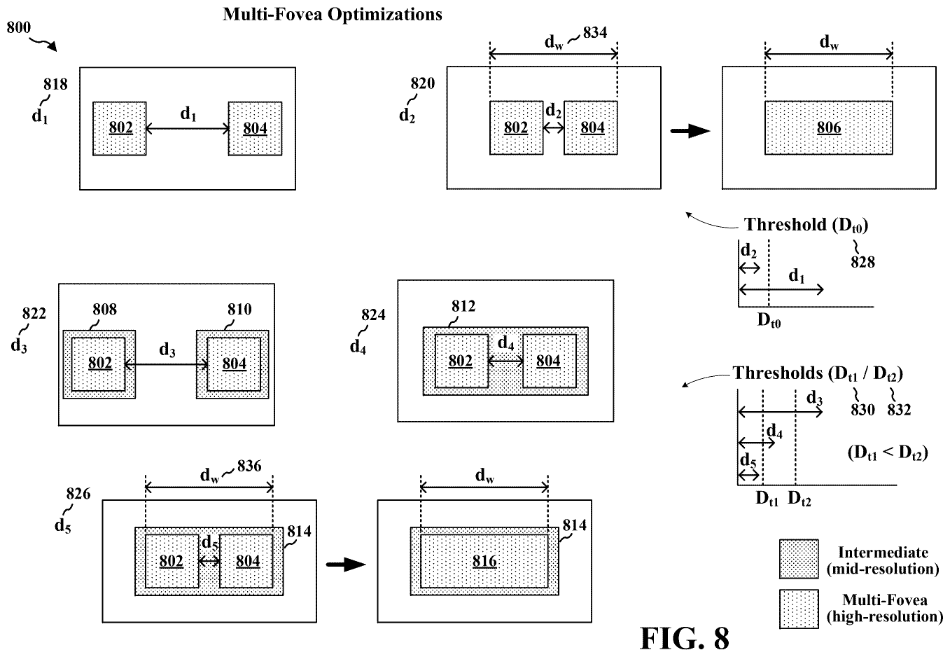

FIG. 8 illustrates a diagram 800 for examples of multi-fovea region optimizations in accordance with one or more techniques of this disclosure. Diagram 800 shows optimizations for multiple fovea regions (e.g., two or more, while two fovea regions are provided, by way of example and not limitation), illustrated as a fovea region 802 and a fovea region 804. Periphery regions are not shown for illustrative clarity, yet aspects provide for periphery regions associated with the examples in diagram 800, as described herein. Optimizations, as described below, may be based on thresholds associated with distances between the fovea region 802 and the fovea region 804. A fovea distance threshold 828 (Dt0) may be used to determine if the fovea region 802 and the fovea region 804 are joined/fused, a fovea distance threshold 832 (Dt2) may be used to determine a number of intermediate regions, and a fovea distance threshold 830 (Dt1) may be used to determine if the fovea region 802 and the fovea region 804 are joined/fused in association with the number of intermediate regions.

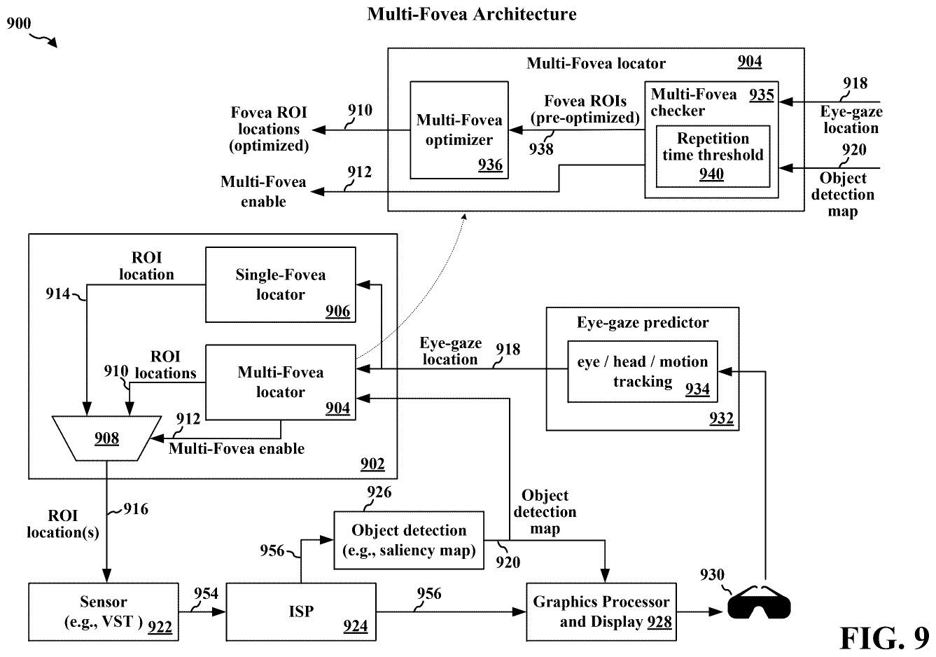

In one example, the fovea region 802 and the fovea region 804 may be separated in an image frame by a distance 818 (d1). In aspects, the distance 818 (d1) may meet a threshold condition associated with the fovea distance threshold 828 (Dt0). For example, the distance 818 (d1) may be greater than the fovea distance threshold 828 (Dt0), or may be greater than or equal to the fovea distance threshold 828 (Dt0). In such cases, a multi-fovea processor (e.g., via a multi-fovea optimizer, shown in further detail for FIG. 9) and/or the like may be configured to keep the fovea region 802 and the fovea region 804 separate.

In one example, the fovea region 802 and the fovea region 804 may be separated in an image frame by a distance 820 (d2). In aspects, the distance 820 (d2) may fail to meet a threshold condition associated with the fovea distance threshold 828 (Dt0). For example, the distance 820 (d2) may be less than the fovea distance threshold 828 (Dt0), or may be less than or equal to the fovea distance threshold 828 (Dt0). In such cases, a multi-fovea processor (e.g., via a multi-fovea optimizer) and/or the like may be configured to join/fuse the fovea region 802 and the fovea region 804 together as a joined fovea region 806. In some aspects, the outer edges of the fovea region 802 and the fovea region 804 may be separated by a distance 834 (dw), and the width of the joined fovea region 806 may also be distance 834 (dw). That is, the area between the fovea region 802 and the fovea region 804 may be included in the joined fovea region 806.

In one example, the fovea region 802 and the fovea region 804 may be associated with an intermediate region 808 and an intermediate region 810, respectively. The fovea region 802 and the fovea region 804 may be separated in an image frame by a distance 822 (d3). In aspects, the distance 822 (d3) may meet a threshold condition associated with a fovea distance threshold 832 (Dt2). For example, the distance 822 (d3) may be greater than the fovea distance threshold 832 (Dt2), or may be greater than or equal to the fovea distance threshold 832 (Dt2). In such cases, a multi-fovea processor (e.g., via a multi-fovea optimizer) and/or the like may be configured to keep the fovea region 802 and the fovea region 804, and correspondingly, the intermediate region 808 the intermediate region 810, separate.

In one example, the fovea region 802 and the fovea region 804 may be separated in an image frame by a distance 824 (d4). In aspects, the distance 824 (d4) may fail to meet a threshold condition associated with the fovea distance threshold 832 (Dt2), but may meet a threshold condition associated with a fovea distance threshold 830 (Dt1). For example, the distance 824 (d4) may be less than the fovea distance threshold 832 (Dt2), or may be less than or equal to the fovea distance threshold 832 (Dt2), while also being greater than the fovea distance threshold 830 (Dt1), or being greater than or equal to the fovea distance threshold 830 (Dt1). In such cases, a multi-fovea processor (e.g., via a multi-fovea optimizer) and/or the like may be configured to keep the fovea region 802 and the fovea region 804 separate, and to join/fuse the intermediate region 808 and the intermediate region 810 together as a joined intermediate region 812.

In one example, the fovea region 802 and the fovea region 804 may be separated in an image frame by a distance 826 (d5). In aspects, the distance 826 (d5) may fail to meet the threshold condition associated with the fovea distance threshold 832 (Dt2), and may also fail to meet the threshold condition associated with the fovea distance threshold 830 (Dt1). For example, the distance 826 (d5) may be less than the fovea distance threshold 832 (Dt2) and less than or equal to the fovea distance threshold 830 (Dt1). In such cases, a multi-fovea processor (e.g., via a multi-fovea optimizer) and/or the like may be configured to join/fuse the fovea region 802 and the fovea region 804 together as a joined fovea region 816, and to join/fuse the intermediate region 808 and the intermediate region 810 together as a joined intermediate region 814. In aspects, joining/fusing the fovea region 802 and the fovea region 804 together, and joining/fusing the intermediate region 808 and the intermediate region 810 together may be performed as one operation or separately. In some aspects, the outer edges of the fovea region 802 and the fovea region 804 may be separated by a distance 836 (dw), and the width of the joined fovea region 816 may also be distance 836 (dw). That is, the area between the fovea region 802 and the fovea region 804 may be included in the joined fovea region 816. Aspects also provide for (i) generating a single intermediate region (e.g., without joining/fusing) for the fovea region 802 and the fovea region 804 and/or for the joined fovea region 816, and/or (ii) similar considerations for joining/fusing the intermediate region 808 and the intermediate region 810 as for joining/fusing the fovea region 802 and the fovea region 804.

In aspects, the fovea distance threshold 828 (Dt0), the fovea distance threshold 830 (Dt1), and the fovea distance threshold 832 (Dt2) may be configurable and tuned based on the use-cases.

FIG. 9 illustrates a diagram 900 for examples of a multi-fovea architecture in accordance with one or more techniques of this disclosure. In aspects, based on eye-gaze locations (e.g., from an eye-gaze predictor 932), the fovea location(s) for a next image frame may be computed and communicated to a sensor 922 via a multi-fovea processor (MFP) 902. The sensor 922 may be configured to send/provide image frames with different ROI location(s) 916 (e.g., for fovea regions, an intermediate region(s), and/or a periphery region, as described herein). In aspects, the MFP 902 may also include other components, described herein, such as those shown for FIG. 9.

In aspects, the MFP 902 may be configured to receive an eye-gaze location 918 from the eye-gaze predictor 932 utilizing eye/head/motion tracking 934. The MFP 902 may also be configured to receive an object detection map 920 based on object detection (at 926) (e.g., via a saliency map). In aspects, the object detection map 920 may be based on a prior image frame. Utilizing the object detection map 920 and the eye-gaze location 918, the MFP 902 may be configured to determine, e.g., utilizing a multi-fovea locator 904, if there is a repetitive behavior of a user to continuously alter the focus of their eye-gaze between two or more objects/physical monitors (e.g., a determination of repetitive eye behavior) and to output ROI locations 910 associated with the two or more objects. When such a determination is made, the MFP 902 may be configured to enable multi-fovea regions via the multi-fovea locator 904 and a multi-fovea enable 912 (e.g., as activated), while when this determination is not made, the MFP 902 may be configured to disable multi-fovea regions and utilize a single-fovea region via a single-fovea locator 906 (e.g., the multi-fovea enable 912 is deactivated) that outputs an ROI location 914 associated with a single object that is focused on by the user.

A selector 908 may be configured to select the ROI locations 910 or the ROI location 914 based on the multi-fovea enable 912 being activated or not, respectively. The output of the selector 908 thus represents ROI location(s) 916 based on the selection via the multi-fovea enable 912. The sensor 922 receives the ROI location(s) 916 may be configured to perform sensing by which camera image frames are combined with virtual image frames for display to the user, e.g., as multi-foveated image data 954. An ISP 924 may be configured to receive the output of the sensor 922 and perform the object detection (at 926) to generate the object detection map 920. The ISP 924 may also be configured to process the VST image frames (e.g., as processed multi-foveated image data 956) and provide the processed VST image frames and the object detection map 920 to downstream processors (e.g., graphics processor and display processor 928) for display via a HMD 930. The HMD 930 may be configured, based on the displayed image frames and the eye-gaze predictor 932, to provide an updated instance of the eye-gaze location 918.

With reference to the multi-fovea locator 904, a multi-fovea checker 935 and a multi-fovea optimizer 936 are shown. The multi-fovea checker 935 may be configured to receive an eye-gaze location 918, as described above for the multi-fovea locator 904, and to determine if there is a repetitive behavior of the user to continuously alter the focus of their eye-gaze between two or more objects/physical monitors (e.g., a determination of repetitive eye behavior). In some aspects, the multi-fovea checker 935 may be configured to determine if the repetitive behavior persists for a configurable duration of time, e.g., for a repetition time threshold 940. That is, when the repetitive eye behavior occurs continuously for a certain period of time defined by the repetition time threshold 940, the multi-fovea checker 935 may be configured to activate the multi-fovea enable 912 for utilization of multi-fovea regions, according to aspects. The multi-fovea checker 935 may also be configured to provide fovea ROIs 938 that are associated with objects in image frames that correspond to the repetitive eye behavior and that are pre-optimized to the multi-fovea optimizer 936.

The multi-fovea optimizer 936 may be configured to perform multi-fovea optimizations, e.g., as described above with reference to FIG. 8, and to provide the optimized outputs as the ROI locations 910. For example, the multi-fovea optimizer 936 may be configured to perform the optimizations, described for and illustrated in FIG. 8, to determine the number of fovea regions and intermediate regions, and their corresponding ROIs (e.g., based on fovea separation distance).

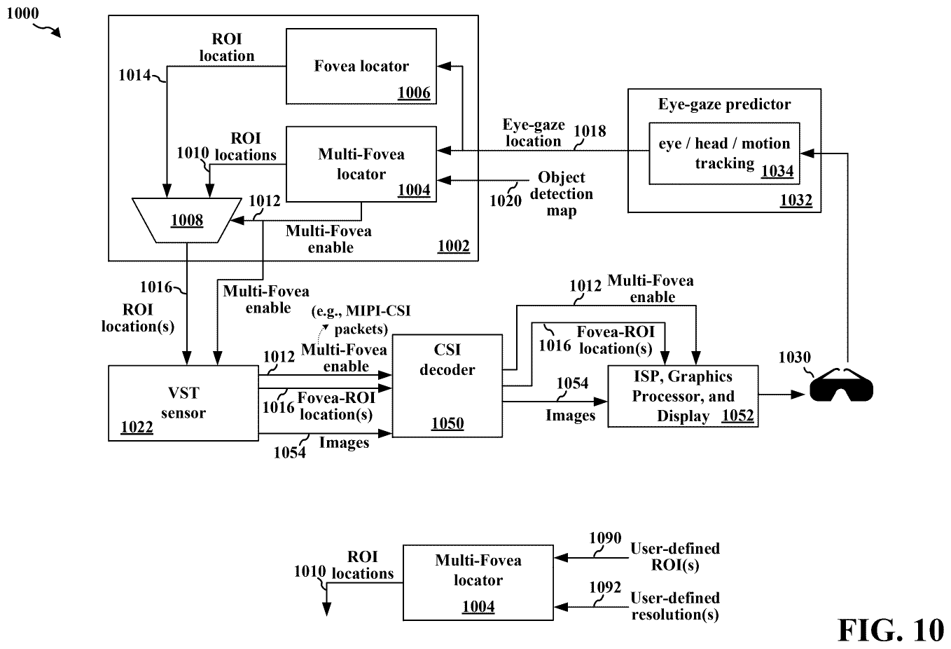

FIG. 10 illustrates a diagram 1000 for a multi-fovea architecture with synchronization in accordance with one or more techniques of this disclosure. In aspects, based on eye-gaze locations (e.g., from an eye-gaze predictor 1032), the fovea location(s) for a next image frame may be computed and communicated to a sensor 1022 via a MFP 1002. The sensor 1022 may be configured to send/provide image frames with different ones of ROI location(s) 1016 (e.g., for fovea regions, an intermediate region(s), and/or a periphery region, as described herein). The diagram 1000 may be an aspect of the diagram 900 in FIG. 9. In aspects, the MFP 1002 may also include other components, described herein, such as those shown for FIG. 10.

In aspects, the MFP 1002 may be configured to receive an eye-gaze location 1018 from the eye-gaze predictor 1032 utilizing eye/head/motion tracking 1034. The MFP 1002 may also be configured to receive an object detection map 1020 based on object detection (e.g., via a saliency map). In aspects, the object detection map 1020 may be based on a prior image frame. Utilizing the object detection map 1020 and the eye-gaze location 1018, the MFP 1002 may be configured to determine, e.g., utilizing a multi-fovea locator 1004, if there is a repetitive behavior of a user to continuously alter the focus of their eye-gaze between two or more objects/physical monitors (e.g., a determination of repetitive eye behavior) and to output ROI locations 1010 associated with the two or more objects. When such a determination is made, the MFP 1002 may be configured to enable multi-fovea regions via the multi-fovea locator 1004 and a multi-fovea enable 1012 (e.g., as activated), while when this determination is not made, the MFP 1002 may be configured to disable multi-fovea regions and utilize a single-fovea region via a single-fovea locator 1006 (e.g., the multi-fovea enable 1012 is deactivated) that outputs an ROI location 1014 associated with a single object that is focused on by the user.

A selector 1008 may be configured to select the ROI locations 1010 or the ROI location 1014 based on the multi-fovea enable 1012 being activated or not, respectively. The output of the selector 1008 thus represents ROI location(s) 1016 based on the selection via the multi-fovea enable 1012. The sensor 1022 receives the ROI location(s) 1016 may be configured to perform sensing by which camera image frames are combined with virtual image frames for display to the user.

In aspects, the multi-fovea locator may be configured to provide the multi-fovea enable 1012 to the sensor 1022 for end-to-end synchronization purposes, along with the ROI location(s) 1016 and processed VST image frames 1054, e.g., multi-foveated image data. For instance, the multi-fovea enable 1012 may be provided to a camera serial interface (CSI) decoder 1050 from the sensor 1022 via encoded mobile industry processor interface (MIPI)-CSI packets. The CSI decoder 1050 may be configured to decode the encoded MIPI-CSI packets to obtain the multi-fovea enable 1012 information. The CSI decoder 1050 may then be configured to provide the multi-fovea enable 1012 information with the ROI location(s) 1016 to downstream processors 1052 for synchronization with the processed VST image frames 1054 (e.g., an ISP, a graphics processor, a display processor, and/or the like). The ISP, the graphics processor, the display processor, the HMD 1030, and/or the like, may perform aspects as described above with reference to FIG. 9.

In some aspects, user-specified ROIs and/or resolutions may be provided and utilized for the multi-fovea regions, described herein. For instance, the MFP 1002/the multi-fovea locator 1004 may be configured to receive a user-defined ROI(s) 1090 and/or a user-defined resolution(s) 1092. For example, a user may define multiple ROIs, which can then be used to determine the multi-fovea regions describe above. The user may also define multiple resolutions that correspond to the multiple ROIs. The MFP 1002 may be configured to bypass a repetition time threshold when the user-defined ROI(s) 1090 are provided. In some aspects, the user-defined ROI(s) 1090 may be combined with fovea ROIs determined based on the eye-gaze location 1018 and the object detection map 1020. In some aspects, the user-defined ROI(s) 1090 may be optimized via the multi-fovea locator 1004 (e.g., using a multi-fovea optimizer, such as the multi-fovea optimizer 936 in FIG. 9) with or without fovea ROIs determined based on the eye-gaze location 1018 and the object detection map 1020. The user-defined ROI(s) 1090 may be defined via software (e.g., a driver, an application, etc.), a user interface, and/or the like, in various aspects. Accordingly, multi-fovea regions with user-specified locations and resolutions are created.

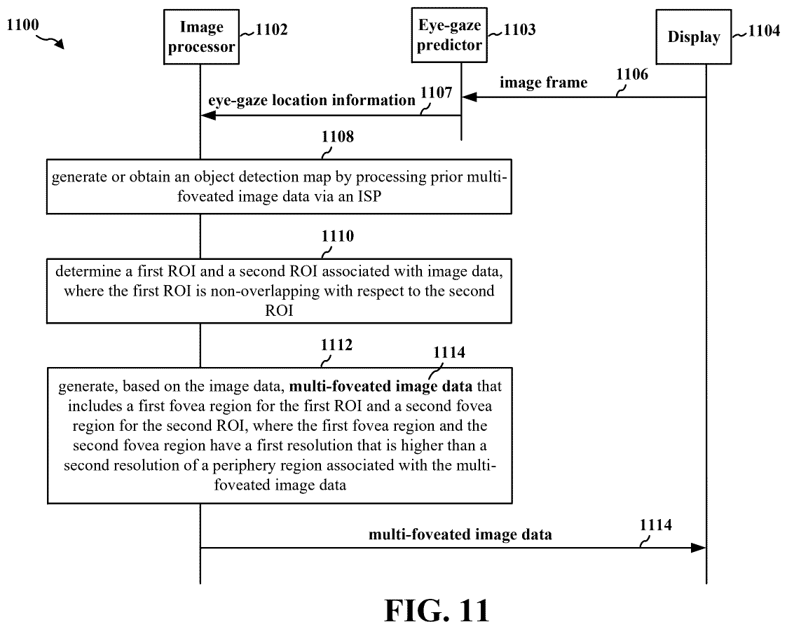

FIG. 11 is a call flow diagram 1100 illustrating example communications between an image processor 1102 and a display 1104 in accordance with one or more techniques of this disclosure. In aspects, call flow diagram 1100 is described for multi-fovea regions for viewer gaze changes. In an example, the image processor 1102 may be or include the processing unit 120/the multi-fovea processor 198 (MFP), a CPU, a GPU, a neural processing unit (NPU), a hardware accelerator, and/or the like. In aspects, as shown, an eye-gaze predictor 1103 may also communicate with the image processor 1102 and the display 1104. In aspects, the image processor 1102 comprises a wireless communication device that is configured to perform the call flow diagram 1100.

The image processor 1102 may be configured to receive/obtain eye-gaze location information 1107 from the eye-gaze predictor 1103. The eye-gaze predictor 1103 may generate/determine the eye-gaze location information 1107 based on an image frame 1106 received by the eye-gaze predictor 1103 from the display 1104 (e.g., from a display panel, HMD, etc.).

At 1108, the image processor 1102 generates or obtains an object detection map by processing prior multi-foveated image data via an ISP. In aspects, the image processor 1102 may include the ISP. In aspects, to generate/obtain the object detection map, the image processor 1102 may be configured to perform one more functions. For example, to generate/obtain the object detection map, the image processor 1102 may be configured to generate the object detection map based on video see-through sensing associated with the first ROI and the second ROI. As another example, to generate/obtain the object detection map, the image processor 1102 may be configured to generate processed multi-foveated image data via the ISP. As another example, to output the multi-foveated image data, image processor 1102 may be configured to provide the object detection map and the processed multi-foveated image data via the ISP for a display panel via at least one of a graphics processor or a display processor.

At 1110, the image processor 1102 determines a first ROI and a second ROI associated with image data, where the first ROI is non-overlapping with respect to the second ROI. In aspects, the image processor 1102 determines the first ROI and the second ROI associated with the image data is based on the object detection map. In aspects, to determine the first ROI and the second ROI, the image processor 1102 may be configured to determine a third ROI. In such aspects, the multi-foveated image data 1114 may include a third fovea region for the third ROI, and a third portion of the multi-foveated image data 1114 for the third fovea region may include the first resolution. In aspects, to determine the first ROI and the second ROI, the image processor 1102 may be configured to determine, based on an input of a user, at least one of (i) a first location of the first ROI and a second location of the second ROI or (ii) the first resolution. In aspects, to determine the first ROI and the second ROI, the image processor 1102 may be configured to activate a multi-fovea selection for the multi-foveated image data 1114 via an activation signal. In some aspects, the first fovea region and the second fovea region are associated with a single display panel. In such aspects, the single display panel may be associated with a HMD, a first wireless communication device, a first mobile computing device, a first stationary computing device, a first monitor, a first television, and/or the like. In some aspects, the first fovea region is associated with a first display panel of multiple display panels and the second fovea region is associated with a second display panel of the multiple display panels that is different from the first display panel. In such aspects, the first display panel may be associated with one of a second mobile computing device, a second stationary computing device, a second monitor, a second television, and/or the like, and the second display panel may be associated with another of the second mobile computing device, the second stationary computing device, the second monitor, the second television, and/or the like. In aspects, the image data may be associated with a first eye-gaze location corresponding to the first ROI and a second eye-gaze location corresponding to the second ROI. In such aspects, the image processor 1102 may be configured to determine the first ROI and the second ROI associated with the image data is based on the first eye-gaze location and the second eye-gaze location. In such aspects, the first eye-gaze location and the second eye-gaze location may be based on a set of eye-gaze predictions associated with user tracking information of repetitive eye behavior and a repetition time threshold.

At 1112, the image processor 1102 generates, based on the image data, multi-foveated image data 1114 that includes a first fovea region for the first ROI and a second fovea region for the second ROI, where the first fovea region and the second fovea region have a first resolution that is higher than a second resolution of a periphery region associated with the multi-foveated image data 1114. In aspects, where a third ROI is determined, the multi-foveated image data 1114 may include a third fovea region for the third ROI, and a third portion of the multi-foveated image data 1114 for the third fovea region may include the first resolution. In aspects, the multi-foveated image data 1114 includes a first intermediate region and a second intermediate region each having a third resolution that is higher than the second resolution of the periphery region and lower than the first resolution. In such aspects the first intermediate region surrounds the first fovea region and the second intermediate region surrounds the second fovea region based on (i) a distance that separates the first intermediate region and the second intermediate region and (ii) an intermediate distance threshold. In aspects, the multi-foveated image data 1114 includes an intermediate region with a third resolution that is higher than the second resolution and lower than the first resolution, and the intermediate region surrounds the first fovea region and the second fovea region and is based on (i) a distance that separates the first fovea region and the second fovea region, (ii) an intermediate distance threshold, and (iii) a fovea distance threshold. In aspects, the multi-foveated image data 1114 includes a joined fovea region that comprises the first fovea region, the second fovea region, and an interstitial region therebetween based on (i) a first distance that separates the first fovea region and the second fovea region and (ii) a fovea distance threshold. The joined fovea region may have the first resolution. In aspects, the first fovea region and the second fovea region are separate regions based on (i) a distance that separates the first fovea region and the second fovea region and (ii) the fovea distance threshold. In aspects, the multi-foveated image data 1114 includes the joined fovea region and an intermediate region with a third resolution that is higher than the second resolution and lower than the first resolution, and the intermediate region surrounds the joined fovea region and is based on (i) a second distance that separates the first fovea region and the second fovea region and (ii) the fovea distance threshold.

The image processor 1102 outputs the multi-foveated image data 1114. The image processor 1102 may be configured to output the multi-foveated image data 1114 for the display 1104. In aspects for which the multi-fovea selection for the multi-foveated image data 1114 is activated via an activation signal, the image processor 1102 may be configured to output the multi-foveated image data, the processor is configured to output, via video see-through sensing and based on the first fovea region and the second fovea region included in the multi-foveated image data, an encoded synchronization indication indicative of multi-foveation in the multi-foveated image data. In aspects for which the multi-fovea selection for the multi-foveated image data 1114 is activated via an activation signal, the image processor 1102 may be configured to output, via video see-through (VST) sensing, the activation signal as an encoded synchronization indication for further image processing via a decoder. In such aspects, the encoded synchronization indication comprises encoded metadata and the decoder is a CSI decoder (e.g., the encoded metadata may include an ROI location(s) (e.g., for fovea, intermediate fovea, etc.) and/or multi-fovea enable information/signaling, such as that described herein for FIGS. 9, 10). In such aspects, to output the encoded synchronization indication, the image processor 1102 may be configured to obtain, by the CSI decoder, a decoded synchronization indication based on a decode of the encoded synchronization indication, and to provide the decoded synchronization indication for the further image processing. In aspects, to output the multi-foveated image data 1114, the image processor 1102 may be configured to store the multi-foveated image data 1114 in memory and/or to provide the multi-foveated image data 1114 for downstream image processing prior to displaying the multi-foveated image data 1114.

The image processor 1102 may be configured to generate or obtain an object detection map (e.g., a subsequent object detection map with respect to 1108) by processing the multi-foveated image data 1114 via an ISP. In aspects, to generate/obtain the object detection map, the image processor 1102 may be configured to perform one more functions. For example, to generate/obtain the object detection map, the image processor 1102 may be configured to generate the object detection map based on video see-through sensing associated with the first ROI and the second ROI. As another example, to generate/obtain the object detection map, the image processor 1102 may be configured to generate processed multi-foveated image data via the ISP. As another example, to output the multi-foveated image data, image processor 1102 may be configured to provide the object detection map and the processed multi-foveated image data via the ISP for a display panel via at least one of a graphics processor or a display processor.

The image processor 1102 may be configured to determine a third ROI and a fourth ROI associated with subsequent image data based on the object detection map, and the third ROI may be associated with the first ROI and the fourth ROI may be associated with the second ROI. In aspects, the image processor 1102 determines the third ROI and the fourth ROI associated with the subsequent image data based on the object detection map.

The image processor 1102 may be configured to generate, based on the subsequent image data, subsequent multi-foveated image data that includes a third fovea region for the third ROI and a fourth fovea region for the fourth ROI. In aspects, the third fovea region and the fourth fovea region have the first resolution that is higher than the second resolution of a periphery region. In aspects, a third ROI may be determined for the subsequent image data, and the subsequent multi-foveated image data may include a third fovea region for the third ROI at the first resolution. In aspects, the subsequent multi-foveated image data may include a third intermediate region and a fourth intermediate region each having a third resolution that is higher than the second resolution of the periphery region and lower than the first resolution. In such aspects the third intermediate region surrounds the third fovea region and the fourth intermediate region surrounds the fourth fovea region based on (i) the distance that separates the third intermediate region and the fourth intermediate region and (ii) the intermediate distance threshold. In aspects, the subsequent multi-foveated image data may include an intermediate region with a third resolution that is higher than the second resolution and lower than the first resolution, and the intermediate region may surround the third fovea region and the fourth fovea region and is based on (i) a distance that separates the third fovea region and the fourth fovea region, (ii) the intermediate distance threshold, and (iii) the fovea distance threshold. In aspects, the subsequent multi-foveated image data may include a second joined fovea region that comprises the third fovea region, the fourth fovea region, and an interstitial region therebetween based on (i) a distance that separates the third fovea region and the fourth fovea region and (ii) a fovea distance threshold. The second joined fovea region may have the first resolution. In aspects, the third fovea region and the fourth fovea region may be separate regions based on (i) a distance that separates the third fovea region and the fourth fovea region and (ii) the fovea distance threshold. In aspects, the subsequent multi-foveated image data may include the second joined fovea region and an intermediate region with a third resolution that is higher than the second resolution and lower than the first resolution, and the intermediate region surrounds the second joined fovea region and is based on (i) a distance that separates the third fovea region and the fourth fovea region and (ii) the fovea distance threshold.

The image processor 1102 may be configured to output the subsequent multi-foveated image data for additional image processing. In aspects for which the multi-fovea selection for the subsequent multi-foveated image data is activated via an activation signal, the image processor 1102 may be configured to output the subsequent multi-foveated image data, the processor is configured to output, via video see-through sensing and based on the first fovea region and the second fovea region included in the subsequent multi-foveated image data, an encoded synchronization indication indicative of multi-foveation in the subsequent multi-foveated image data. In aspects for which a multi-fovea selection for the subsequent multi-foveated image data is activated via an activation signal, the image processor 1102 may be configured to output, via video see-through (VST) sensing, the activation signal as an encoded synchronization indication for further image processing via a decoder. In such aspects, the encoded synchronization indication comprises encoded metadata and the decoder is a CSI decoder. In such aspects, to output the encoded synchronization indication, the image processor 1102 may be configured to obtain, by the CSI decoder, a decoded synchronization indication based on a decode of the encoded synchronization indication, and to provide the decoded synchronization indication for the further image processing. In aspects, to output the subsequent multi-foveated image data, the image processor 1102 may be configured to store the subsequent multi-foveated image data in memory and/or to provide the subsequent multi-foveated image data for downstream image processing prior to displaying the subsequent multi-foveated image data.

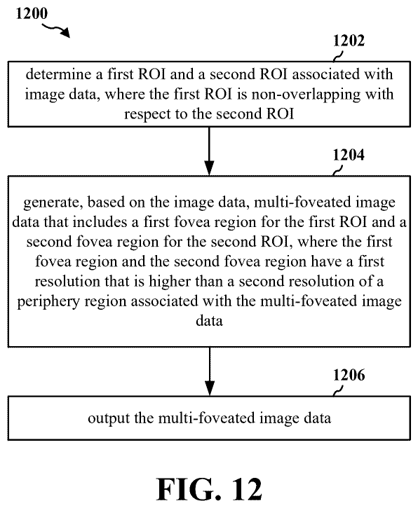

FIG. 12 is a flowchart 1200 of an example method of image processing in accordance with one or more techniques of this disclosure. The method may be for multi-fovea regions for viewer gaze changes. The method may be performed by an apparatus, such as an apparatus for image processing, a central processor (e.g., a CPU), the multi-fovea processor 198 (MFP), a graphics processor (e.g., a GPU), or other image processor, a wireless communication device, and the like, as used in connection with the aspects of FIGS. 1-11.

At 1202, the apparatus may determine a first ROI and a second ROI associated with image data, where the first ROI is non-overlapping with respect to the second ROI. For example, referring to FIG. 11, the image processor 1102 may be configured to receive/obtain eye-gaze location information 1107 (e.g., 918 in FIG. 9; 1018 in FIG. 10) from the eye-gaze predictor 1103 (e.g., 932 in FIG. 9; 1032 in FIG. 10). The eye-gaze predictor 1103 (e.g., 932 in FIG. 9; 1032 in FIG. 10) may generate/determine the eye-gaze location information 1107 (e.g., 918 in FIG. 9; 1018 in FIG. 10) based on an image frame 1106 (e.g., 704 in FIG. 7) received by the eye-gaze predictor 1103 (e.g., 932 in FIG. 9; 1032 in FIG. 10) from the display 1104 (e.g., from a display panel (e.g., 610, 612, 613 in FIG. 6), HMD (e.g., 613 in FIG. 6; 930 in FIG. 9; 1030 in FIG. 10), etc.). At 1108, the image processor 1102 generates or obtains (e.g., at 926 in FIG. 9) an object detection map (e.g., 920 in FIG. 9; 1020 in FIG. 10) by processing prior multi-foveated image data (e.g., 954 in FIG. 9; 1054 in FIG. 10) via an ISP (e.g., 924 in FIG. 9; 1052 in FIG. 10). In aspects, to generate/obtain (e.g., at 926 in FIG. 9) the object detection map (e.g., 920 in FIG. 9; 1020 in FIG. 10), the image processor 1102 may be configured to perform one more functions. For example, to generate/obtain (e.g., at 926 in FIG. 9) the object detection map (e.g., 920 in FIG. 9; 1020 in FIG. 10), the image processor 1102 may be configured to generate (e.g., at 926 in FIG. 9) the object detection map (e.g., 920 in FIG. 9; 1020 in FIG. 10) based on video see-through sensing (e.g., 922 in FIG. 9; 1022 in FIG. 10) associated with the first ROI and the second ROI (e.g., 622, 624 in FIG. 6; 910, 916 in FIG. 9; 1010, 1016 in FIG. 10). As another example, to generate/obtain (e.g., at 926 in FIG. 9) the object detection map (e.g., 920 in FIG. 9; 1020 in FIG. 10), the image processor 1102 may be configured to generate processed multi-foveated image data (e.g., 956 in FIG. 9; 1054 in FIG. 10) via the ISP (e.g., 924 in FIG. 9; 1052 in FIG. 10). As another example, to output the multi-foveated image data (e.g., 954, 956 in FIG. 9; 1054 in FIG. 10), image processor 1102 may be configured to provide the object detection map (e.g., 920 in FIG. 9; 1020 in FIG. 10) and the processed multi-foveated image data (e.g., 956 in FIG. 9; 1054 in FIG. 10) via the ISP (e.g., 924 in FIG. 9; 1052 in FIG. 10) for a display panel (e.g., 610, 612, 613 in FIG. 6; 930 in FIG. 9; 1030 in FIG. 10) via at least one of a graphics processor or a display processor. At 1110, the image processor 1102 determines (e.g., at 904 in FIG. 9; at 1004 in FIG. 10) a first ROI and a second ROI (e.g., 622, 624 in FIG. 6; 910, 916 in FIG. 9; 1010, 1016 in FIG. 10) associated with image data, where the first ROI (e.g., 622, 624 in FIG. 6; 910, 916 in FIG. 9; 1010, 1016 in FIG. 10) is non-overlapping with respect to the second ROI (e.g., 622, 624 in FIG. 6; 910, 916 in FIG. 9; 1010, 1016 in FIG. 10). In aspects, the image processor 1102 determines (e.g., at 904 in FIG. 9; at 1004 in FIG. 10) the first ROI and the second ROI (e.g., 622, 624 in FIG. 6; 910, 916 in FIG. 9; 1010, 1016 in FIG. 10) associated with the image data is based on the object detection map (e.g., 920 in FIG. 9; 1020 in FIG. 10). In aspects, to determine (e.g., at 904 in FIG. 9; at 1004 in FIG. 10) the first ROI and the second ROI (e.g., 622, 624 in FIG. 6; 910, 916 in FIG. 9; 1010, 1016 in FIG. 10), the image processor 1102 may be configured to determine (e.g., at 904 in FIG. 9; at 1004 in FIG. 10) a third ROI (e.g., for 718 in FIG. 7). In aspects, to determine the first ROI and the second ROI (e.g., 622, 624 in FIG. 6; 910, 916 in FIG. 9; 1010, 1016 in FIG. 10), the image processor 1102 may be configured to determine (e.g., at 904 in FIG. 9; at 1004 in FIG. 10), based on an input of a user, at least one of (i) a first location of the first ROI and a second location of the second ROI (e.g., 622, 624 in FIG. 6; 910, 916 in FIG. 9; 1010, 1016 in FIG. 10) or (ii) the first resolution. In aspects, to determine (e.g., at 904 in FIG. 9; at 1004 in FIG. 10) the first ROI and the second ROI (e.g., 622, 624 in FIG. 6; 910, 916 in FIG. 9; 1010, 1016 in FIG. 10), the image processor 1102 may be configured to activate a multi-fovea selection (e.g., via 908 in FIG. 9; 1008 in FIG. 10) for the multi-foveated image data 1114 (e.g., 954, 956 in FIG. 9; 1054 in FIG. 10) via an activation signal (e.g., via 912 in FIG. 9; 1012 in FIG. 10). In some aspects, the first fovea region and the second fovea region (e.g., 654, 656, 660, 662 in FIG. 6; 708, 710, 714, 716, 718, 722, 724 in FIG. 7; 802, 804 in FIG. 8) are associated with a single display panel (e.g., 610, 612, 613 in FIG. 6; 930 in FIG. 9; 1030 in FIG. 10). In such aspects, the single display panel (e.g., 610, 612, 613 in FIG. 6; 930 in FIG. 9; 1030 in FIG. 10) may be associated with a HMD (e.g., 613 in FIG. 6; 930 in FIG. 9; 1030 in FIG. 10), a first wireless communication device, a first mobile computing device, a first stationary computing device, a first monitor, a first television, and/or the like. In some aspects, the first fovea region (e.g., 654, 656, 660, 662 in FIG. 6; 708, 710, 714, 716, 718, 722, 724 in FIG. 7; 802, 804 in FIG. 8) is associated with a first display panel (e.g., 610 in FIG. 6) of multiple display panels (e.g., 610, 612 in FIG. 6) and the second fovea region (e.g., 654, 656, 660, 662 in FIG. 6; 708, 710, 714, 716, 718, 722, 724 in FIG. 7; 802, 804 in FIG. 8) is associated with a second display panel (e.g., 612 in FIG. 6) of the multiple display panels (e.g., 610, 612 in FIG. 6) that is different from the first display panel (e.g., 610 in FIG. 6). In such aspects, the first display panel (e.g., 610 in FIG. 6) may be associated with one of a second mobile computing device, a second stationary computing device, a second monitor, a second television, and/or the like, and the second display panel (e.g., 612 in FIG. 6) may be associated with another of the second mobile computing device, the second stationary computing device, the second monitor, the second television, and/or the like. In aspects, the image data may be associated with a first eye-gaze location corresponding to the first ROI (e.g., 622, 624 in FIG. 6; 910, 916 in FIG. 9; 1010, 1016 in FIG. 10) and a second eye-gaze location corresponding to the second ROI (e.g., 622, 624 in FIG. 6; 910, 916 in FIG. 9; 1010, 1016 in FIG. 10). In such aspects, the image processor 1102 may be configured to determine (e.g., at 904, 935 in FIG. 9; at 1004 in FIG. 10) the first ROI and the second ROI (e.g., 622, 624 in FIG. 6; 910, 916 in FIG. 9; 1010, 1016 in FIG. 10) associated with the image data is based on the first eye-gaze location and the second eye-gaze location (e.g., at 918 in FIG. 9; at 1018 in FIG. 10). In such aspects, the first eye-gaze location and the second eye-gaze location (e.g., at 918 in FIG. 9; at 1018 in FIG. 10) may be based on a set of eye-gaze predictions (e.g., at 932 in FIG. 9; at 1032 in FIG. 10) associated with user tracking information (e.g., 934 in FIG. 9; 1034 in FIG. 10) of repetitive eye behavior and a repetition time threshold (e.g., 940 in FIG. 9; 1040 in FIG. 10). In aspects for the third ROI (e.g., for 718 in FIG. 7), the multi-foveated image data 1114 (e.g., 954, 956 in FIG. 9; 1054 in FIG. 10) may include a third fovea region (e.g., 718 in FIG. 7) for the third ROI (e.g., for 718 in FIG. 7), and a third portion of the multi-foveated image data 1114 (e.g., 954, 956 in FIG. 9; 1054 in FIG. 10) for the third fovea region (e.g., 718 in FIG. 7) may include the first resolution.

At 1204, the apparatus may generate, based on the image data, multi-foveated image data that includes a first fovea region for the first ROI and a second fovea region for the second ROI, where the first fovea region and the second fovea region have a first resolution that is higher than a second resolution of a periphery region associated with the multi-foveated image data. For example, referring to FIG. 11, at 1112, the image processor 1102 generates, based on the image data, multi-foveated image data 1114 (e.g., 954, 956 in FIG. 9; 1054 in FIG. 10) that includes a first fovea region (e.g., 654, 656, 660, 662 in FIG. 6; 708, 710, 714, 716, 718, 722, 724 in FIG. 7; 802, 804 in FIG. 8) for the first ROI (e.g., 622, 624 in FIG. 6; 910, 916 in FIG. 9; 1010, 1016 in FIG. 10) and a second fovea region (e.g., 654, 656, 660, 662 in FIG. 6; 708, 710, 714, 716, 718, 722, 724 in FIG. 7; 802, 804 in FIG. 8) for the second ROI (e.g., 622, 624 in FIG. 6; 910, 916 in FIG. 9; 1010, 1016 in FIG. 10), where the first fovea region and the second fovea region (e.g., 654, 656, 660, 662 in FIG. 6; 708, 710, 714, 716, 718, 722, 724 in FIG. 7; 802, 804 in FIG. 8) have a first resolution that is higher than a second resolution of a periphery region (e.g., 618/618, 626/630 in FIG. 6; 706 in FIG. 7) associated with the multi-foveated image data 1114 (e.g., 954, 956 in FIG. 9; 1054 in FIG. 10). In aspects, where a third ROI (e.g., for 718 in FIG. 7) is determined, the multi-foveated image data 1114 (e.g., 954, 956 in FIG. 9; 1054 in FIG. 10) may include a third fovea region (e.g., 718 in FIG. 7) for the third ROI (e.g., for 718 in FIG. 7), and a third portion of the multi-foveated image data 1114 (e.g., 954, 956 in FIG. 9; 1054 in FIG. 10) for the third fovea region (e.g., 718 in FIG. 7) may include the first resolution. In aspects, the multi-foveated image data 1114 (e.g., 954, 956 in FIG. 9; 1054 in FIG. 10) includes a first intermediate region and a second intermediate region (e.g., 726, 728 in FIG. 7; 808, 810 in FIG. 8) each having a third resolution that is higher than the second resolution of the periphery region (e.g., 618/618, 626/630 in FIG. 6; 706 in FIG. 7) and lower than the first resolution. In such aspects the first intermediate region (e.g., 726 in FIG. 7; 808 in FIG. 8) surrounds the first fovea region (e.g., 654, 656, 660, 662 in FIG. 6; 708, 710, 714, 716, 718, 722, 724 in FIG. 7; 802, 804 in FIG. 8) and the second intermediate region (e.g., 728 in FIG. 7; 810 in FIG. 8) surrounds the second fovea region (e.g., 654, 656, 660, 662 in FIG. 6; 708, 710, 714, 716, 718, 722, 724 in FIG. 7; 802, 804 in FIG. 8) based on (i) a distance (e.g., 822 in FIG. 8) that separates the first intermediate region and the second intermediate region (e.g., 726, 728 in FIG. 7; 808, 810 in FIG. 8) and (ii) an intermediate distance threshold (e.g., 832 in FIG. 8). In aspects, the multi-foveated image data 1114 (e.g., 954, 956 in FIG. 9; 1054 in FIG. 10) includes an intermediate region (e.g., 720 in FIG. 7; 812 in FIG. 8) with a third resolution that is higher than the second resolution and lower than the first resolution, and the intermediate region (e.g., 720 in FIG. 7; 812 in FIG. 8) surrounds the first fovea region and the second fovea region (e.g., 654, 656, 660, 662 in FIG. 6; 708, 710, 714, 716, 718, 722, 724 in FIG. 7; 802, 804 in FIG. 8) and is based on (i) a distance (e.g., 824 in FIG. 8) that separates the first fovea region and the second fovea region (e.g., 654, 656, 660, 662 in FIG. 6; 708, 710, 714, 716, 718, 722, 724 in FIG. 7; 802, 804 in FIG. 8), (ii) an intermediate distance threshold (e.g., 830 in FIG. 8), and (iii) a fovea distance threshold (e.g., 826 in FIG. 8). In aspects, the multi-foveated image data 1114 (e.g., 954, 956 in FIG. 9; 1054 in FIG. 10) includes a joined fovea region (e.g., 806, 816 in FIG. 8) that comprises the first fovea region (e.g., 654, 656, 660, 662 in FIG. 6; 708, 710, 714, 716, 718, 722, 724 in FIG. 7; 802, 804 in FIG. 8), the second fovea region (e.g., 654, 656, 660, 662 in FIG. 6; 708, 710, 714, 716, 718, 722, 724 in FIG. 7; 802, 804 in FIG. 8), and an interstitial region therebetween based on (i) a first distance (e.g., 820, 826 in FIG. 8) that separates the first fovea region and the second fovea region (e.g., 654, 656, 660, 662 in FIG. 6; 708, 710, 714, 716, 718, 722, 724 in FIG. 7; 802, 804 in FIG. 8) and (ii) a fovea distance threshold (e.g., 828 in FIG. 8). The joined fovea region (e.g., 806, 816 in FIG. 8) may have the first resolution. In aspects, the first fovea region and the second fovea region (e.g., 654, 656, 660, 662 in FIG. 6; 708, 710, 714, 716, 718, 722, 724 in FIG. 7; 802, 804 in FIG. 8) are separate regions based on (i) a distance (e.g., 818 in FIG. 8) that separates the first fovea region and the second fovea region (e.g., 654, 656, 660, 662 in FIG. 6; 708, 710, 714, 716, 718, 722, 724 in FIG. 7; 802, 804 in FIG. 8) and (ii) the fovea distance threshold (e.g., 828 in FIG. 8). In aspects, the multi-foveated image data 1114 (e.g., 954, 956 in FIG. 9; 1054 in FIG. 10) includes the joined fovea region (e.g., 806, 816 in FIG. 8) and an intermediate region (e.g., 720 in FIG. 7; 814 in FIG. 8) with a third resolution that is higher than the second resolution and lower than the first resolution, and the intermediate region (e.g., 720 in FIG. 7; 814 in FIG. 8) surrounds the joined fovea region (e.g., 806, 816 in FIG. 8) and is based on (i) a second distance (e.g., 826 in FIG. 8) that separates the first fovea region and the second fovea region (e.g., 654, 656, 660, 662 in FIG. 6; 708, 710, 714, 716, 718, 722, 724 in FIG. 7; 802, 804 in FIG. 8) and (ii) the fovea distance threshold (e.g., 828 in FIG. 8).

At 1206, the apparatus may output the multi-foveated image data. For example, referring to FIG. 11, the image processor 1102 outputs the multi-foveated image data 1114 (e.g., 954, 956 in FIG. 9; 1054 in FIG. 10). In aspects for which the multi-fovea selection (e.g., via 908 in FIG. 9; 1008 in FIG. 10) for the multi-foveated image data 1114 (e.g., 954, 956 in FIG. 9; 1054 in FIG. 10) is activated via an activation signal (e.g., via 912 in FIG. 9; 1012 in FIG. 10), the image processor 1102 may be configured to output the multi-foveated image data (e.g., 954, 956 in FIG. 9; 1054 in FIG. 10), the processor is configured to output, via video see-through sensing (e.g., 922 in FIG. 9; 1022 in FIG. 10) and based on the first fovea region and the second fovea region (e.g., 654, 656, 660, 662 in FIG. 6; 708, 710, 714, 716, 718, 722, 724 in FIG. 7; 802, 804 in FIG. 8) included in the multi-foveated image data (e.g., 954, 956 in FIG. 9; 1054 in FIG. 10), an encoded synchronization indication (e.g., 1012 via MIPI-CSI in FIG. 10) indicative of multi-foveation in the multi-foveated image data (e.g., 954, 956 in FIG. 9; 1054 in FIG. 10). In aspects for which the multi-fovea selection (e.g., via 908 in FIG. 9; 1008 in FIG. 10) for the multi-foveated image data 1114 (e.g., 954, 956 in FIG. 9; 1054 in FIG. 10) is activated via an activation signal (e.g., via 912 in FIG. 9; 1012 in FIG. 10), the image processor 1102 may be configured to output, via VST sensing (e.g., 922 in FIG. 9; 1022 in FIG. 10), the activation signal (e.g., via 912 in FIG. 9; 1012 in FIG. 10) as an encoded synchronization indication (e.g., 1012 via MIPI-CSI in FIG. 10) for further image processing via a decoder (e.g., 1050 in FIG. 10). In such aspects, the encoded synchronization indication (e.g., 1012 via MIPI-CSI in FIG. 10) comprises encoded metadata and the decoder (e.g., 1050 in FIG. 10) is a CSI decoder. In such aspects, to output the encoded synchronization indication (e.g., 1012 via MIPI-CSI in FIG. 10), the image processor 1102 may be configured to obtain, by the CSI decoder (e.g., 1050 in FIG. 10), a decoded synchronization indication (e.g., via 912 in FIG. 9; 1012 in FIG. 10) based on a decode of the encoded synchronization indication (e.g., 1012 via MIPI-CSI in FIG. 10), and to provide the decoded synchronization indication (e.g., via 912 in FIG. 9; 1012 in FIG. 10) for the further image processing. In aspects, to output the multi-foveated image data 1114 (e.g., 954, 956 in FIG. 9; 1054 in FIG. 10), the image processor 1102 may be configured to store the multi-foveated image data 1114 (e.g., 954, 956 in FIG. 9; 1054 in FIG. 10) in memory and/or to provide the multi-foveated image data 1114 (e.g., 954, 956 in FIG. 9; 1054 in FIG. 10) for downstream image processing (e.g., at 928 in FIG. 9; at 1052 in FIG. 10) prior to displaying (e.g., via 610, 612, 613 in FIG. 6; via 930 in FIG. 9; via 1030 in FIG. 10) the multi-foveated image data 1114 (e.g., 954, 956 in FIG. 9; 1054 in FIG. 10).

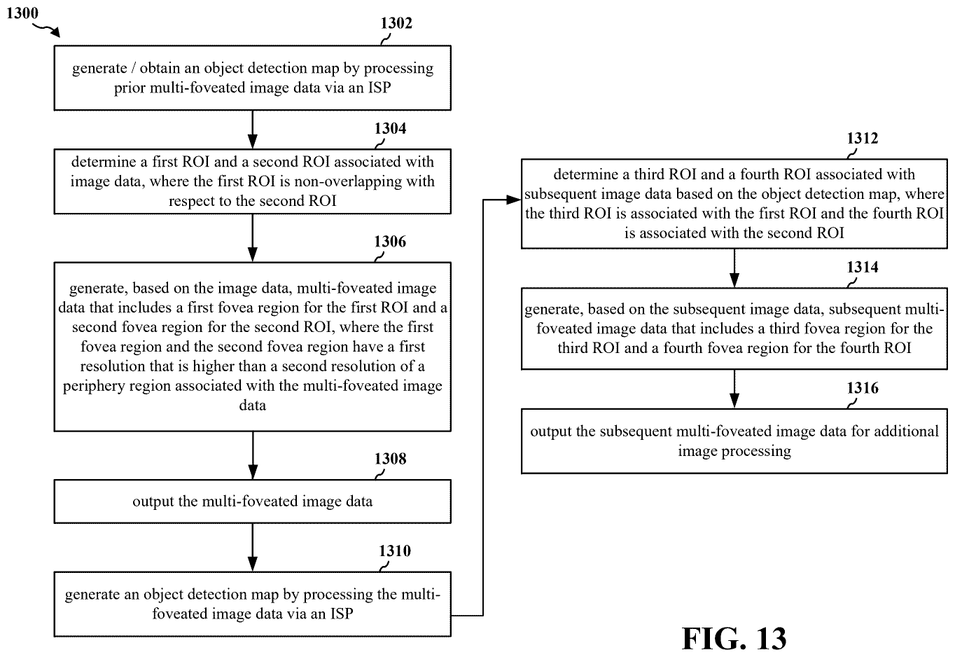

FIG. 13 is a flowchart 1300 of an example method of image processing in accordance with one or more techniques of this disclosure. The method may be for multi-fovea regions for viewer gaze changes. The method may be performed by an apparatus, such as an apparatus for image processing, a central processor (e.g., CPU), the multi-fovea processor 198 (MFP), a graphics processor (e.g., GPU), or other image processor, a wireless communication device, and the like, as used in connection with the aspects of FIGS. 1-11.

At 1302, the apparatus may generate or obtain an object detection map by processing prior multi-foveated image data via an ISP. For example, referring to FIG. 11, at 1108, the image processor 1102 generates or obtains (e.g., at 926 in FIG. 9) an object detection map (e.g., 920 in FIG. 9; 1020 in FIG. 10) by processing prior multi-foveated image data (e.g., 954 in FIG. 9; 1054 in FIG. 10) via an ISP (e.g., 924 in FIG. 9; 1052 in FIG. 10). In aspects, to generate/obtain (e.g., at 926 in FIG. 9) the object detection map (e.g., 920 in FIG. 9; 1020 in FIG. 10), the image processor 1102 may be configured to perform one more functions. For example, to generate/obtain (e.g., at 926 in FIG. 9) the object detection map (e.g., 920 in FIG. 9; 1020 in FIG. 10), the image processor 1102 may be configured to generate (e.g., at 926 in FIG. 9) the object detection map (e.g., 920 in FIG. 9; 1020 in FIG. 10) based on video see-through sensing (e.g., 922 in FIG. 9; 1022 in FIG. 10) associated with the first ROI and the second ROI (e.g., 622, 624 in FIG. 6; 910, 916 in FIG. 9; 1010, 1016 in FIG. 10). As another example, to generate/obtain (e.g., at 926 in FIG. 9) the object detection map (e.g., 920 in FIG. 9; 1020 in FIG. 10), the image processor 1102 may be configured to generate processed multi-foveated image data (e.g., 956 in FIG. 9; 1054 in FIG. 10) via the ISP (e.g., 924 in FIG. 9; 1052 in FIG. 10). As another example, to output the multi-foveated image data (e.g., 954, 956 in FIG. 9; 1054 in FIG. 10), image processor 1102 may be configured to provide the object detection map (e.g., 920 in FIG. 9; 1020 in FIG. 10) and the processed multi-foveated image data (e.g., 956 in FIG. 9; 1054 in FIG. 10) via the ISP (e.g., 924 in FIG. 9; 1052 in FIG. 10) for a display panel (e.g., 610, 612, 613 in FIG. 6; 930 in FIG. 9; 1030 in FIG. 10) via at least one of a graphics processor or a display processor..

At 1304, the apparatus may determine a first ROI and a second ROI associated with image data, where the first ROI is non-overlapping with respect to the second ROI. For example, referring to FIG. 11, the image processor 1102 may be configured to receive/obtain eye-gaze location information 1107 (e.g., 918 in FIG. 9; 1018 in FIG. 10) from the eye-gaze predictor 1103 (e.g., 932 in FIG. 9; 1032 in FIG. 10). The eye-gaze predictor 1103 (e.g., 932 in FIG. 9; 1032 in FIG. 10) may generate/determine the eye-gaze location information 1107 (e.g., 918 in FIG. 9; 1018 in FIG. 10) based on an image frame 1106 (e.g., 704 in FIG. 7) received by the eye-gaze predictor 1103 (e.g., 932 in FIG. 9; 1032 in FIG. 10) from the display 1104 (e.g., from a display panel (e.g., 610, 612, 613 in FIG. 6), HMD (e.g., 613 in FIG. 6; 930 in FIG. 9; 1030 in FIG. 10), etc.). At 1110, the image processor 1102 determines (e.g., at 904 in FIG. 9; at 1004 in FIG. 10) a first ROI and a second ROI (e.g., 622, 624 in FIG. 6; 910, 916 in FIG. 9; 1010, 1016 in FIG. 10) associated with image data, where the first ROI (e.g., 622, 624 in FIG. 6; 910, 916 in FIG. 9; 1010, 1016 in FIG. 10) is non-overlapping with respect to the second ROI (e.g., 622, 624 in FIG. 6; 910, 916 in FIG. 9; 1010, 1016 in FIG. 10). In aspects, the image processor 1102 determines (e.g., at 904 in FIG. 9; at 1004 in FIG. 10) the first ROI and the second ROI (e.g., 622, 624 in FIG. 6; 910, 916 in FIG. 9; 1010, 1016 in FIG. 10) associated with the image data is based on the object detection map (e.g., 920 in FIG. 9; 1020 in FIG. 10). In aspects, to determine (e.g., at 904 in FIG. 9; at 1004 in FIG. 10) the first ROI and the second ROI (e.g., 622, 624 in FIG. 6; 910, 916 in FIG. 9; 1010, 1016 in FIG. 10), the image processor 1102 may be configured to determine (e.g., at 904 in FIG. 9; at 1004 in FIG. 10) a third ROI (e.g., for 718 in FIG. 7). In aspects, to determine the first ROI and the second ROI (e.g., 622, 624 in FIG. 6; 910, 916 in FIG. 9; 1010, 1016 in FIG. 10), the image processor 1102 may be configured to determine (e.g., at 904 in FIG. 9; at 1004 in FIG. 10), based on an input of a user, at least one of (i) a first location of the first ROI and a second location of the second ROI (e.g., 622, 624 in FIG. 6; 910, 916 in FIG. 9; 1010, 1016 in FIG. 10) or (ii) the first resolution. In aspects, to determine (e.g., at 904 in FIG. 9; at 1004 in FIG. 10) the first ROI and the second ROI (e.g., 622, 624 in FIG. 6; 910, 916 in FIG. 9; 1010, 1016 in FIG. 10), the image processor 1102 may be configured to activate a multi-fovea selection (e.g., via 908 in FIG. 9; 1008 in FIG. 10) for the multi-foveated image data 1114 (e.g., 954, 956 in FIG. 9; 1054 in FIG. 10) via an activation signal (e.g., via 912 in FIG. 9; 1012 in FIG. 10). In some aspects, the first fovea region and the second fovea region (e.g., 654, 656, 660, 662 in FIG. 6; 708, 710, 714, 716, 718, 722, 724 in FIG. 7; 802, 804 in FIG. 8) are associated with a single display panel (e.g., 610, 612, 613 in FIG. 6; 930 in FIG. 9; 1030 in FIG. 10). In such aspects, the single display panel (e.g., 610, 612, 613 in FIG. 6; 930 in FIG. 9; 1030 in FIG. 10) may be associated with a HMD (e.g., 613 in FIG. 6; 930 in FIG. 9; 1030 in FIG. 10), a first wireless communication device, a first mobile computing device, a first stationary computing device, a first monitor, a first television, and/or the like. In some aspects, the first fovea region (e.g., 654, 656, 660, 662 in FIG. 6; 708, 710, 714, 716, 718, 722, 724 in FIG. 7; 802, 804 in FIG. 8) is associated with a first display panel (e.g., 610 in FIG. 6) of multiple display panels (e.g., 610, 612 in FIG. 6) and the second fovea region (e.g., 654, 656, 660, 662 in FIG. 6; 708, 710, 714, 716, 718, 722, 724 in FIG. 7; 802, 804 in FIG. 8) is associated with a second display panel (e.g., 612 in FIG. 6) of the multiple display panels (e.g., 610, 612 in FIG. 6) that is different from the first display panel (e.g., 610 in FIG. 6). In such aspects, the first display panel (e.g., 610 in FIG. 6) may be associated with one of a second mobile computing device, a second stationary computing device, a second monitor, a second television, and/or the like, and the second display panel (e.g., 612 in FIG. 6) may be associated with another of the second mobile computing device, the second stationary computing device, the second monitor, the second television, and/or the like. In aspects, the image data may be associated with a first eye-gaze location corresponding to the first ROI (e.g., 622, 624 in FIG. 6; 910, 916 in FIG. 9; 1010, 1016 in FIG. 10) and a second eye-gaze location corresponding to the second ROI (e.g., 622, 624 in FIG. 6; 910, 916 in FIG. 9; 1010, 1016 in FIG. 10). In such aspects, the image processor 1102 may be configured to determine (e.g., at 904, 935 in FIG. 9; at 1004 in FIG. 10) the first ROI and the second ROI (e.g., 622, 624 in FIG. 6; 910, 916 in FIG. 9; 1010, 1016 in FIG. 10) associated with the image data is based on the first eye-gaze location and the second eye-gaze location (e.g., at 918 in FIG. 9; at 1018 in FIG. 10). In such aspects, the first eye-gaze location and the second eye-gaze location (e.g., at 918 in FIG. 9; at 1018 in FIG. 10) may be based on a set of eye-gaze predictions (e.g., at 932 in FIG. 9; at 1032 in FIG. 10) associated with user tracking information (e.g., 934 in FIG. 9; 1034 in FIG. 10) of repetitive eye behavior and a repetition time threshold (e.g., 940 in FIG. 9; 1040 in FIG. 10). In aspects for the third ROI (e.g., for 718 in FIG. 7), the multi-foveated image data 1114 (e.g., 954, 956 in FIG. 9; 1054 in FIG. 10) may include a third fovea region (e.g., 718 in FIG. 7) for the third ROI (e.g., for 718 in FIG. 7), and a third portion of the multi-foveated image data 1114 (e.g., 954, 956 in FIG. 9; 1054 in FIG. 10) for the third fovea region (e.g., 718 in FIG. 7) may include the first resolution.

At 1306, the apparatus may generate, based on the image data, multi-foveated image data that includes a first fovea region for the first ROI and a second fovea region for the second ROI, where the first fovea region and the second fovea region have a first resolution that is higher than a second resolution of a periphery region associated with the multi-foveated image data. For example, referring to FIG. 11, at 1112, the image processor 1102 generates, based on the image data, multi-foveated image data 1114 (e.g., 954, 956 in FIG. 9; 1054 in FIG. 10) that includes a first fovea region (e.g., 654, 656, 660, 662 in FIG. 6; 708, 710, 714, 716, 718, 722, 724 in FIG. 7; 802, 804 in FIG. 8) for the first ROI (e.g., 622, 624 in FIG. 6; 910, 916 in FIG. 9; 1010, 1016 in FIG. 10) and a second fovea region (e.g., 654, 656, 660, 662 in FIG. 6; 708, 710, 714, 716, 718, 722, 724 in FIG. 7; 802, 804 in FIG. 8) for the second ROI (e.g., 622, 624 in FIG. 6; 910, 916 in FIG. 9; 1010, 1016 in FIG. 10), where the first fovea region and the second fovea region (e.g., 654, 656, 660, 662 in FIG. 6; 708, 710, 714, 716, 718, 722, 724 in FIG. 7; 802, 804 in FIG. 8) have a first resolution that is higher than a second resolution of a periphery region (e.g., 618/618, 626/630 in FIG. 6; 706 in FIG. 7) associated with the multi-foveated image data 1114 (e.g., 954, 956 in FIG. 9; 1054 in FIG. 10). In aspects, where a third ROI (e.g., for 718 in FIG. 7) is determined, the multi-foveated image data 1114 (e.g., 954, 956 in FIG. 9; 1054 in FIG. 10) may include a third fovea region (e.g., 718 in FIG. 7) for the third ROI (e.g., for 718 in FIG. 7), and a third portion of the multi-foveated image data 1114 (e.g., 954, 956 in FIG. 9; 1054 in FIG. 10) for the third fovea region (e.g., 718 in FIG. 7) may include the first resolution. In aspects, the multi-foveated image data 1114 (e.g., 954, 956 in FIG. 9; 1054 in FIG. 10) includes a first intermediate region and a second intermediate region (e.g., 726, 728 in FIG. 7; 808, 810 in FIG. 8) each having a third resolution that is higher than the second resolution of the periphery region (e.g., 618/618, 626/630 in FIG. 6; 706 in FIG. 7) and lower than the first resolution. In such aspects the first intermediate region (e.g., 726 in FIG. 7; 808 in FIG. 8) surrounds the first fovea region (e.g., 654, 656, 660, 662 in FIG. 6; 708, 710, 714, 716, 718, 722, 724 in FIG. 7; 802, 804 in FIG. 8) and the second intermediate region (e.g., 728 in FIG. 7; 810 in FIG. 8) surrounds the second fovea region (e.g., 654, 656, 660, 662 in FIG. 6; 708, 710, 714, 716, 718, 722, 724 in FIG. 7; 802, 804 in FIG. 8) based on (i) a distance (e.g., 822 in FIG. 8) that separates the first intermediate region and the second intermediate region (e.g., 726, 728 in FIG. 7; 808, 810 in FIG. 8) and (ii) an intermediate distance threshold (e.g., 832 in FIG. 8). In aspects, the multi-foveated image data 1114 (e.g., 954, 956 in FIG. 9; 1054 in FIG. 10) includes an intermediate region (e.g., 720 in FIG. 7; 812 in FIG. 8) with a third resolution that is higher than the second resolution and lower than the first resolution, and the intermediate region (e.g., 720 in FIG. 7; 812 in FIG. 8) surrounds the first fovea region and the second fovea region (e.g., 654, 656, 660, 662 in FIG. 6; 708, 710, 714, 716, 718, 722, 724 in FIG. 7; 802, 804 in FIG. 8) and is based on (i) a distance (e.g., 824 in FIG. 8) that separates the first fovea region and the second fovea region (e.g., 654, 656, 660, 662 in FIG. 6; 708, 710, 714, 716, 718, 722, 724 in FIG. 7; 802, 804 in FIG. 8), (ii) an intermediate distance threshold (e.g., 830 in FIG. 8), and (iii) a fovea distance threshold (e.g., 826 in FIG. 8). In aspects, the multi-foveated image data 1114 (e.g., 954, 956 in FIG. 9; 1054 in FIG. 10) includes a joined fovea region (e.g., 806, 816 in FIG. 8) that comprises the first fovea region (e.g., 654, 656, 660, 662 in FIG. 6; 708, 710, 714, 716, 718, 722, 724 in FIG. 7; 802, 804 in FIG. 8), the second fovea region (e.g., 654, 656, 660, 662 in FIG. 6; 708, 710, 714, 716, 718, 722, 724 in FIG. 7; 802, 804 in FIG. 8), and an interstitial region therebetween based on (i) a first distance (e.g., 820, 826 in FIG. 8) that separates the first fovea region and the second fovea region (e.g., 654, 656, 660, 662 in FIG. 6; 708, 710, 714, 716, 718, 722, 724 in FIG. 7; 802, 804 in FIG. 8) and (ii) a fovea distance threshold (e.g., 828 in FIG. 8). The joined fovea region (e.g., 806, 816 in FIG. 8) may have the first resolution. In aspects, the first fovea region and the second fovea region (e.g., 654, 656, 660, 662 in FIG. 6; 708, 710, 714, 716, 718, 722, 724 in FIG. 7; 802, 804 in FIG. 8) are separate regions based on (i) a distance (e.g., 818 in FIG. 8) that separates the first fovea region and the second fovea region (e.g., 654, 656, 660, 662 in FIG. 6; 708, 710, 714, 716, 718, 722, 724 in FIG. 7; 802, 804 in FIG. 8) and (ii) the fovea distance threshold (e.g., 828 in FIG. 8). In aspects, the multi-foveated image data 1114 (e.g., 954, 956 in FIG. 9; 1054 in FIG. 10) includes the joined fovea region (e.g., 806, 816 in FIG. 8) and an intermediate region (e.g., 720 in FIG. 7; 814 in FIG. 8) with a third resolution that is higher than the second resolution and lower than the first resolution, and the intermediate region (e.g., 720 in FIG. 7; 814 in FIG. 8) surrounds the joined fovea region (e.g., 806, 816 in FIG. 8) and is based on (i) a second distance (e.g., 826 in FIG. 8) that separates the first fovea region and the second fovea region (e.g., 654, 656, 660, 662 in FIG. 6; 708, 710, 714, 716, 718, 722, 724 in FIG. 7; 802, 804 in FIG. 8) and (ii) the fovea distance threshold (e.g., 828 in FIG. 8).

At 1308, the apparatus may output the multi-foveated image data. For example, referring to FIG. 11, the image processor 1102 outputs the multi-foveated image data 1114 (e.g., 954, 956 in FIG. 9; 1054 in FIG. 10). In aspects for which the multi-fovea selection (e.g., via 908 in FIG. 9; 1008 in FIG. 10) for the multi-foveated image data 1114 (e.g., 954, 956 in FIG. 9; 1054 in FIG. 10) is activated via an activation signal, the image processor 1102 may be configured to output the multi-foveated image data (e.g., 954, 956 in FIG. 9; 1054 in FIG. 10), the processor is configured to output, via video see-through sensing (e.g., 922 in FIG. 9; 1022 in FIG. 10) and based on the first fovea region and the second fovea region (e.g., 654, 656, 660, 662 in FIG. 6; 708, 710, 714, 716, 718, 722, 724 in FIG. 7; 802, 804 in FIG. 8) included in the multi-foveated image data (e.g., 954, 956 in FIG. 9; 1054 in FIG. 10), an encoded synchronization indication (e.g., 1012 via MIPI-CSI in FIG. 10) indicative of multi-foveation in the multi-foveated image data (e.g., 954, 956 in FIG. 9; 1054 in FIG. 10). In aspects for which the multi-fovea selection (e.g., via 908 in FIG. 9; 1008 in FIG. 10) for the multi-foveated image data 1114 (e.g., 954, 956 in FIG. 9; 1054 in FIG. 10) is activated via an activation signal (e.g., via 912 in FIG. 9; 1012 in FIG. 10), the image processor 1102 may be configured to output, via VST sensing (e.g., 922 in FIG. 9; 1022 in FIG. 10), the activation signal (e.g., via 912 in FIG. 9; 1012 in FIG. 10) as an encoded synchronization indication (e.g., 1012 via MIPI-CSI in FIG. 10) for further image processing via a decoder (e.g., 1050 in FIG. 10). In such aspects, the encoded synchronization indication (e.g., 1012 via MIPI-CSI in FIG. 10) comprises encoded metadata and the decoder (e.g., 1050 in FIG. 10) is a CSI decoder. In such aspects, to output the encoded synchronization indication (e.g., 1012 via MIPI-CSI in FIG. 10), the image processor 1102 may be configured to obtain, by the CSI decoder (e.g., 1050 in FIG. 10), a decoded synchronization indication (e.g., via 912 in FIG. 9; 1012 in FIG. 10) based on a decode of the encoded synchronization indication (e.g., 1012 via MIPI-CSI in FIG. 10), and to provide the decoded synchronization indication (e.g., via 912 in FIG. 9; 1012 in FIG. 10) for the further image processing. In aspects, to output the multi-foveated image data 1114 (e.g., 954, 956 in FIG. 9; 1054 in FIG. 10), the image processor 1102 may be configured to store the multi-foveated image data 1114 (e.g., 954, 956 in FIG. 9; 1054 in FIG. 10) in memory and/or to provide the multi-foveated image data 1114 (e.g., 954, 956 in FIG. 9; 1054 in FIG. 10) for downstream image processing (e.g., at 928 in FIG. 9; at 1052 in FIG. 10) prior to displaying (e.g., via 610, 612, 613 in FIG. 6; via 930 in FIG. 9; via 1030 in FIG. 10) the multi-foveated image data 1114 (e.g., 954, 956 in FIG. 9; 1054 in FIG. 10).

At 1310, the apparatus may generate an object detection map by processing the multi-foveated image data via an ISP. The object detection map may be a subsequent object detection map with respect to 1302. For example, referring to FIG. 11, the image processor 1102 may be configured to generate or obtain an object detection map (e.g., a subsequent object detection map (e.g., 920 in FIG. 9; 1020 in FIG. 10) with respect to 1108) by processing the multi-foveated image data 1114 (e.g., 954, 956 in FIG. 9; 1054 in FIG. 10) via an ISP (e.g., 924 in FIG. 9; 1052 in FIG. 10). In aspects, to generate/obtain the object detection map (e.g., 920 in FIG. 9; 1020 in FIG. 10), the image processor 1102 may be configured to perform one more functions. For example, to generate/obtain the object detection map (e.g., 920 in FIG. 9; 1020 in FIG. 10), the image processor 1102 may be configured to generate the object detection map (e.g., 920 in FIG. 9; 1020 in FIG. 10) based on video see-through sensing (e.g., 922 in FIG. 9; 1022 in FIG. 10) associated with the first ROI and the second ROI (e.g., 622, 624 in FIG. 6; 910, 916 in FIG. 9; 1010, 1016 in FIG. 10). As another example, to generate/obtain the object detection map (e.g., 920 in FIG. 9; 1020 in FIG. 10), the image processor 1102 may be configured to generate processed multi-foveated image data (e.g., 956 in FIG. 9; 1054 in FIG. 10) via the ISP (e.g., 924 in FIG. 9; 1052 in FIG. 10).

At 1312, the apparatus may determine a third ROI and a fourth ROI associated with subsequent image data based on the object detection map, where the third ROI is associated with the first ROI and the fourth ROI is associated with the second ROI. For example, referring to FIG. 11, the image processor 1102 may be configured to determine a third ROI and a fourth ROI associated with subsequent image data based on the object detection map (e.g., 920 in FIG. 9; 1020 in FIG. 10), and the third ROI may be associated with the first ROI (e.g., 622, 624 in FIG. 6; 910, 916 in FIG. 9; 1010, 1016 in FIG. 10) and the fourth ROI may be associated with the second ROI (e.g., 622, 624 in FIG. 6; 910, 916 in FIG. 9; 1010, 1016 in FIG. 10), e.g., as similarly described (at 1304) for the image data. In aspects, the image processor 1102 determines the third ROI and the fourth ROI associated with the subsequent image data based on the object detection map (e.g., 920 in FIG. 9; 1020 in FIG. 10).

At 1314, the apparatus may generate, based on the subsequent image data, subsequent multi-foveated image data that includes a third fovea region for the third ROI and a fourth fovea region for the fourth ROI. In aspects, the apparatus may be configured to generate the subsequent multi-foveated image data that includes a third fovea region for the third ROI and a fourth fovea region for the fourth ROI as similarly described above (at 1306) for the multi-foveated image data 1114. For example, referring to FIG. 11, the image processor 1102 may be configured to generate, based on the subsequent image data, subsequent multi-foveated image data that includes a third fovea region for the third ROI and a fourth fovea region for the fourth ROI. In aspects, the third fovea region and the fourth fovea region have the first resolution that is higher than the second resolution of a periphery region. In aspects, a third ROI may be determined for the subsequent image data, and the subsequent multi-foveated image data may include a third fovea region for the third ROI at the first resolution. In aspects, the subsequent multi-foveated image data may include a third intermediate region and a fourth intermediate region each having a third resolution that is higher than the second resolution of the periphery region and lower than the first resolution. In such aspects the third intermediate region surrounds the third fovea region and the fourth intermediate region surrounds the fourth fovea region based on (i) the distance (e.g., 822 in FIG. 8) that separates the third intermediate region and the fourth intermediate region and (ii) the intermediate distance threshold (e.g., 832 in FIG. 8). In aspects, the subsequent multi-foveated image data may include an intermediate region with a third resolution that is higher than the second resolution and lower than the first resolution, and the intermediate region may surround the third fovea region and the fourth fovea region and is based on (i) a distance (e.g., 824 in FIG. 8) that separates the third fovea region and the fourth fovea region, (ii) the intermediate distance threshold (e.g., 830 in FIG. 8), and (iii) the fovea distance threshold (e.g., 826 in FIG. 8). In aspects, the subsequent multi-foveated image data may include a second joined fovea region that comprises the third fovea region, the fourth fovea region, and an interstitial region therebetween based on (i) a distance (e.g., 820, 826 in FIG. 8) that separates the third fovea region and the fourth fovea region and (ii) a fovea distance threshold (e.g., 828 in FIG. 8). The second joined fovea region may have the first resolution. In aspects, the third fovea region and the fourth fovea region may be separate regions based on (i) a distance (e.g., 818 in FIG. 8) that separates the third fovea region and the fourth fovea region and (ii) the fovea distance threshold (e.g., 828 in FIG. 8). In aspects, the subsequent multi-foveated image data may include the second joined fovea region and an intermediate region with a third resolution that is higher than the second resolution and lower than the first resolution, and the intermediate region surrounds the second joined fovea region and is based on (i) a distance (e.g., 826 in FIG. 8) that separates the third fovea region and the fourth fovea region and (ii) the fovea distance threshold (e.g., 828 in FIG. 8).

At 1316, the apparatus may output the subsequent multi-foveated image data for additional image processing. For example, referring to FIG. 11, the image processor 1102 may be configured to output the subsequent multi-foveated image data for additional image processing. In aspects for which the multi-fovea selection (e.g., via 908 in FIG. 9; 1008 in FIG. 10) for the subsequent multi-foveated image data is activated via an activation signal (e.g., via 912 in FIG. 9; 1012 in FIG. 10), the image processor 1102 may be configured to output the subsequent multi-foveated image data, the processor is configured to output, via video see-through sensing (e.g., 922 in FIG. 9; 1022 in FIG. 10) and based on the first fovea region and the second fovea region (e.g., 654, 656, 660, 662 in FIG. 6; 708, 710, 714, 716, 718, 722, 724 in FIG. 7; 802, 804 in FIG. 8) included in the subsequent multi-foveated image data, an encoded synchronization indication (e.g., 1012 via MIPI-CSI in FIG. 10) indicative of multi-foveation in the subsequent multi-foveated image data. In aspects for which the multi-fovea selection (e.g., via 908 in FIG. 9; 1008 in FIG. 10) for the subsequent multi-foveated image data is activated via an activation signal (e.g., via 912 in FIG. 9; 1012 in FIG. 10), the image processor 1102 may be configured to output, via VST sensing (e.g., 922 in FIG. 9; 1022 in FIG. 10), the activation signal (e.g., via 912 in FIG. 9; 1012 in FIG. 10) as an encoded synchronization indication (e.g., 1012 via MIPI-CSI in FIG. 10) for further image processing via a decoder (e.g., 1050 in FIG. 10). In such aspects, the encoded synchronization indication (e.g., 1012 via MIPI-CSI in FIG. 10) comprises encoded metadata and the decoder (e.g., 1050 in FIG. 10) is a CSI decoder. In such aspects, to output the encoded synchronization indication (e.g., 1012 via MIPI-CSI in FIG. 10), the image processor 1102 may be configured to obtain, by the CSI decoder (e.g., 1050 in FIG. 10), a decoded synchronization indication (e.g., via 912 in FIG. 9; 1012 in FIG. 10) based on a decode of the encoded synchronization indication (e.g., 1012 via MIPI-CSI in FIG. 10), and to provide the decoded synchronization indication (e.g., via 912 in FIG. 9; 1012 in FIG. 10) for the further image processing. In aspects, to output the subsequent multi-foveated image data, the image processor 1102 may be configured to store the subsequent multi-foveated image data in memory and/or to provide the subsequent multi-foveated image data for downstream image processing (e.g., at 928 in FIG. 9; at 1052 in FIG. 10) prior to displaying (e.g., via 610, 612, 613 in FIG. 6; via 930 in FIG. 9; via 1030 in FIG. 10) the subsequent multi-foveated image data.

In configurations, a method or an apparatus for image processing is provided. The apparatus may be a central processor (e.g., a CPU), the multi-fovea processor 198 (MFP), a graphics processor (e.g., a GPU), or other image processor that may perform graphics processing. In aspects, the apparatus may be the processing unit 120 within the device 104, or may be some other hardware within the device 104 or another device. The apparatus may include means for determining a first region of interest (ROI) and a second ROI associated with image data where the first ROI is non-overlapping with respect to the second ROI, for generating, based on the image data, multi-foveated image data that includes a first fovea region for the first ROI and a second fovea region for the second ROI, where the first fovea region and the second fovea region have a first resolution that is higher than a second resolution of a periphery region associated with the multi-foveated image data, and for outputting the multi-foveated image data. The apparatus may further include means for generating or obtaining an object detection map by processing prior multi-foveated image data via an ISP. The apparatus may further include means for generating or obtaining an object detection map by processing the multi-foveated image data via an ISP, for determining a third ROI and a fourth ROI associated with subsequent image data based on the object detection map, where the third ROI is associated with the first ROI and the fourth ROI is associated with the second ROI, for generating, based on the subsequent image data, subsequent multi-foveated image data that includes a third fovea region for the third ROI and a fourth fovea region for the fourth ROI, and for outputting the subsequent multi-foveated image data for additional image processing.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of image processing, comprising: determining a first region of interest (ROI) and a second ROI associated with image data, wherein the first ROI is non-overlapping with respect to the second ROI; generating, based on the image data, multi-foveated image data that includes a first fovea region for the first ROI and a second fovea region for the second ROI, wherein the first fovea region and the second fovea region have a first resolution that is higher than a second resolution of a periphery region associated with the multi-foveated image data; and outputting the multi-foveated image data.

Aspect 2 is the method of aspect 1, further comprising: generating, via an image signal processor (ISP), an object detection map by processing prior multi-foveated image data via the ISP; wherein determining the first ROI and the second ROI associated with the image data includes determining the first ROI and the second ROI based on the object detection map.

Aspect 3 is the method of aspect 2, wherein outputting the multi-foveated image data includes: providing the object detection map and processed multi-foveated image data via the ISP for a display panel via at least one of a graphics processor or a display processor.

Aspect 4 is the method of any of aspects 1 to 3, further comprising: generating an object detection map by processing the multi-foveated image data via an image signal processor (ISP); determining a third ROI and a fourth ROI associated with subsequent image data based on the object detection map, wherein the third ROI is associated with the first ROI and the fourth ROI is associated with the second ROI; generating, based on the subsequent image data, subsequent multi-foveated image data that includes a third fovea region for the third ROI and a fourth fovea region for the fourth ROI; and outputting the subsequent multi-foveated image data for additional image processing.

Aspect 5 is the method of any of aspects 1 to 4, wherein the multi-foveated image data includes a first intermediate region and a second intermediate region each having a third resolution that is higher than the second resolution of the periphery region and lower than the first resolution, wherein the first intermediate region surrounds the first fovea region and the second intermediate region surrounds the second fovea region based on (i) a distance that separates the first intermediate region and the second intermediate region and (ii) an intermediate distance threshold.

Aspect 6 is the method of any of aspects 1 to 4, wherein the multi-foveated image data includes an intermediate region with a third resolution that is higher than the second resolution and lower than the first resolution, wherein the intermediate region surrounds the first fovea region and the second fovea region and is based on (i) a distance that separates the first fovea region and the second fovea region and (ii) an intermediate distance threshold.

Aspect 7 is the method of aspect 6, wherein the first fovea region and the second fovea region are separate fovea regions based on (i) a distance that separates the first fovea region and the second fovea region and (ii) a fovea distance threshold.

Aspect 8 is the method of any of aspects 1 to 4, wherein the multi-foveated image data includes a joined fovea region that comprises the first fovea region, the second fovea region, and an interstitial region therebetween, wherein generating the multi-foveated image data includes generating the joined fovea region based on (i) a first distance that separates the first fovea region and the second fovea region and (ii) a fovea distance threshold, wherein the joined fovea region has the first resolution.

Aspect 9 is the method of aspect 8, wherein the multi-foveated image data includes an intermediate region with a third resolution that is higher than the second resolution and lower than the first resolution, wherein generating the multi-foveated image data includes generating the intermediate region to surround the joined fovea region based on (i) a second distance that separates the first fovea region and the second fovea region and (ii) the fovea distance threshold.

Aspect 10 is the method of any of aspects 1 to 4, wherein generating the multi-foveated image data includes generating the first fovea region and the second fovea region as separate regions based on (i) a distance that separates the first fovea region and the second fovea region and (ii) a fovea distance threshold.

Aspect 11 is the method of any of aspects 1 to 10, wherein determining the first ROI and the second ROI associated with the image data includes determining, based on an input of a user, at least one of (i) a first location of the first ROI and a second location of the second ROI or (ii) the first resolution.

Aspect 12 is the method of any of aspects 1 to 11, wherein outputting the multi-foveated image data includes outputting, via video see-through sensing and based on the first fovea region and the second fovea region included in the multi-foveated image data, an encoded synchronization indication indicative of multi-foveation in the multi-foveated image data.

Aspect 13 is the method of any of aspects 1 to 12, wherein the first fovea region and the second fovea region are associated with a single display panel; or wherein the first fovea region is associated with a first display panel of multiple display panels and the second fovea region is associated with a second display panel of the multiple display panels that is different from the first display panel.

Aspect 14 is the method of aspect 12, wherein the method is a head-mounted display (HMD).

Aspect 15 is the method of any of aspects 1 to 14, wherein the image data is associated with a first eye-gaze location corresponding to the first ROI and a second eye-gaze location corresponding to the second ROI; wherein determining the first ROI and the second ROI associated with the image data includes determining the first ROI and the second ROI based on the first eye-gaze location and the second eye-gaze location.

Aspect 16 is the method of aspect 15, wherein the first eye-gaze location and the second eye-gaze location are based on a set of eye-gaze predictions associated with user tracking information of repetitive eye behavior and a repetition time threshold.

Aspect 17 is the method of any of aspects 1 to 16, wherein outputting the multi-foveated image data includes at least one of: storing the multi-foveated image data in the memory; or providing the multi-foveated image data for downstream image processing prior to displaying the multi-foveated image data.

Aspect 18 is an apparatus for graphics processing comprising a processor coupled to a memory and, based on information stored in the memory, the processor is configured to implement a method as in any of aspects 1-17.

Aspect 19 may be combined with aspect 18 and comprises that the apparatus is a wireless communication device.

Aspect 20 is an apparatus for graphics processing comprising means for implementing a method as in any of aspects 1-17.

Aspect 21 is a computer-readable medium (e.g., a non-transitory computer readable-medium) storing computer executable code, the computer executable code, when executed by a processor, causes the processor to implement a method as in any of aspects 1-17.

Various aspects have been described herein. These and other aspects are within the scope of the following claims.

What is claimed is:

1. An apparatus for image processing, comprising:
a memory; and
a processor coupled to the memory and, based on information stored in the memory, the processor is configured to:
determine a first region of interest (ROI) and a second ROI associated with image data, wherein the first ROI is non-overlapping with respect to the second ROI;
generate, based on the image data, multi-foveated image data that includes a first fovea region for the first ROI and a second fovea region for the second ROI, wherein the first fovea region and the second fovea region have a first resolution that is higher than a second resolution of a periphery region associated with the multi-foveated image data; and
output the multi-foveated image data.

2. The apparatus of claim 1, wherein the processor comprises an image signal processor (ISP) and is further configured to:
generate an object detection map by processing prior multi-foveated image data via the ISP;
wherein to determine the first ROI and the second ROI associated with the image data, the processor is configured to determine the first ROI and the second ROI based on the object detection map.

3. The apparatus of claim 2, wherein to output the multi-foveated image data, the processor is configured to:
provide the object detection map and processed multi-foveated image data via the ISP for a display panel via at least one of a graphics processor or a display processor.

4. The apparatus of claim 1, wherein the processor is further configured to:
generate an object detection map by processing the multi-foveated image data via an image signal processor (ISP);
determine a third ROI and a fourth ROI associated with subsequent image data based on the object detection map, wherein the third ROI is associated with the first ROI and the fourth ROI is associated with the second ROI;
generate, based on the subsequent image data, subsequent multi-foveated image data that includes a third fovea region for the third ROI and a fourth fovea region for the fourth ROI; and
output the subsequent multi-foveated image data for additional image processing.

5. The apparatus of claim 1, wherein the multi-foveated image data includes a first intermediate region and a second intermediate region each having a third resolution that is higher than the second resolution of the periphery region and lower than the first resolution, wherein the first intermediate region surrounds the first fovea region and the second intermediate region surrounds the second fovea region based on (i) a distance that separates the first intermediate region and the second intermediate region and (ii) an intermediate distance threshold.

6. The apparatus of claim 1, wherein the multi-foveated image data includes an intermediate region with a third resolution that is higher than the second resolution and lower than the first resolution, wherein the intermediate region surrounds the first fovea region and the second fovea region and is based on (i) a distance that separates the first fovea region and the second fovea region and (ii) an intermediate distance threshold.

7. The apparatus of claim 6, wherein the first fovea region and the second fovea region are separate fovea regions based on (i) a distance that separates the first fovea region and the second fovea region and (ii) a fovea distance threshold.

8. The apparatus of claim 1, wherein the multi-foveated image data includes a joined fovea region that comprises the first fovea region, the second fovea region, and an interstitial region therebetween, wherein to generate the multi-foveated image data, the processor is configured to generate the joined fovea region based on (i) a first distance that separates the first fovea region and the second fovea region and (ii) a fovea distance threshold, wherein the joined fovea region has the first resolution.

9. The apparatus of claim 8, wherein the multi-foveated image data includes an intermediate region with a third resolution that is higher than the second resolution and lower than the first resolution, wherein to generate the multi-foveated image data, the processor is configured to generate the intermediate region to surround the joined fovea region based on (i) a second distance that separates the first fovea region and the second fovea region and (ii) the fovea distance threshold.

10. The apparatus of claim 1, wherein to generate the multi-foveated image data, the processor is configured to generate the first fovea region and the second fovea region as separate regions based on (i) a distance that separates the first fovea region and the second fovea region and (ii) a fovea distance threshold.

11. The apparatus of claim 1, wherein to determine the first ROI and the second ROI associated with the image data, the processor is configured to determine, based on an input of a user, at least one of (i) a first location of the first ROI and a second location of the second ROI or (ii) the first resolution.

12. The apparatus of claim 1, wherein to output the multi-foveated image data, the processor is configured to output, via video see-through sensing and based on the first fovea region and the second fovea region included in the multi-foveated image data, an encoded synchronization indication indicative of multi-foveation in the multi-foveated image data.

13. The apparatus of claim 1, wherein the first fovea region and the second fovea region are associated with a single display panel; or
wherein the first fovea region is associated with a first display panel of multiple display panels and the second fovea region is associated with a second display panel of the multiple display panels that is different from the first display panel.

14. The apparatus of claim 12, wherein the apparatus is a head-mounted display (HMD).

15. The apparatus of claim 1, wherein the image data is associated with a first eye-gaze location corresponding to the first ROI and a second eye-gaze location corresponding to the second ROI;
wherein to determine the first ROI and the second ROI associated with the image data, the processor is configured to determine the first ROI and the second ROI based on the first eye-gaze location and the second eye-gaze location.

16. The apparatus of claim 15, wherein the first eye-gaze location and the second eye-gaze location are based on a set of eye-gaze predictions associated with user tracking information of repetitive eye behavior and a repetition time threshold.

17. The apparatus of claim 1, wherein to output the multi-foveated image data, the processor is configured to at least one of:
store the multi-foveated image data in the memory; or
provide the multi-foveated image data for downstream image processing prior to displaying the multi-foveated image data.

18. The apparatus of claim 1, wherein the apparatus comprises a wireless communication device.

19. A method of image processing, comprising:
determining a first region of interest (ROI) and a second ROI associated with image data, wherein the first ROI is non-overlapping with respect to the second ROI;
generating, based on the image data, multi-foveated image data that includes a first fovea region for the first ROI and a second fovea region for the second ROI, wherein the first fovea region and the second fovea region have a first resolution that is higher than a second resolution of a periphery region associated with the multi-foveated image data; and
outputting the multi-foveated image data.

20. A computer-readable medium storing computer executable code at a device, the code when executed by a processor causes the processor to:
determine a first region of interest (ROI) and a second ROI associated with image data, wherein the first ROI is non-overlapping with respect to the second ROI;
generate, based on the image data, multi-foveated image data that includes a first fovea region for the first ROI and a second fovea region for the second ROI, wherein the first fovea region and the second fovea region have a first resolution that is higher than a second resolution of a periphery region associated with the multi-foveated image data; and
output the multi-foveated image data.
